(19) United States
(12) Patent Application Publication
(10) Pub. No.: US 2004/0020315 A1
(43) Pub. Date: Feb. 5, 2004

(54) Starter for a motor vehicle

(76) Inventors: Gerard Vilou, Tassin La (FR); Chantal Bocquet, Lyon (FR); Olivier Chane-Waye, Lyon (FR); Pascal Jacquin, Chemin du Lichoud (FR)

Correspondence Address: Longacre & White, 6550 Rock Spring Drive, Suite 240, Bethesda, MD, 20817, US

(21) Appl. No.: 10/363,654

(22) PCT Filed: Jul. 10, 2002
(86) PCT No.: PCT/FR02/02426

(30) Foreign Application Priority Data
Jul. 10, 2001 (FR) 01/09433
Nov. 21, 2001 (FR) 01/15245

(51) Int. Cl. F02N 1/00

(52) U.S. Cl. 74/7 A

(57) ABSTRACT

The starter for a motor vehicle comprises a starter head provided with a driver (12) and a pinion (1), an electric motor (M) provided with a shaft (101) able to drive a starter-head shaft (100), an electromagnetic contactor (2) extending parallel to the electric motor (M) above it and comprising a movable core (2d), a fork (13) mounted with articulation at its top end on the movable core (2b); the driver (12) comprises a groove for receiving the bottom end of the fork (13) delimited by two flanks (121, 122) whilst the starter head is locked in rotation by means of cooperation between the fork (13) and the driver (12) for its passage from its idle position to its position of meshing with the starting ring.

### FIELD OF THE INVENTION

The present invention concerns starters for motor vehicles.

### PRIOR ART

Such a starter is depicted in FIG. 1 and comprises an electric motor M mounted inside a first metallic casing, an electromagnetic contactor 2 extending parallel to the electric motor M and comprising a winding 2a mounted inside a second metallic casing. The two casings are fixed, here by means of tie rods, to a support 4 with the interposing here of a support plate 28 of an epicyclic gearbox. The support 4 is a cast part based on aluminium which is intended to be fixed to the crankcase of the internal combustion engine of the motor vehicle, hereinafter referred to as the thermal engine. The support 4 provides the earth return and comprises a front end in the shape of an ogive open locally for the passage of the starting ring C of the vehicle thermal engine. This ogive is connected to an area for fixing and centring respectively the electric motor M, the contactor 2 and the support 2 on the thermal engine crankcase.

The ogive has at the front (the left-hand part in the figure) a support sleeve for a bearing inside which there is mounted for rotation the front end of a starter-head shaft 100 comprising locally at its external periphery flutes able to come into engagement with complementary flutes formed at the internal periphery of a driver 12 belonging to a starter head 102 also comprising a pinion 1 connected by a coupling device 14, here with a freewheel, to the driver.

The shaft 100 is coaxial with the shaft 101 of the electric motor M belonging to the armature of this motor with the interposing here of an epicyclic gearbox between the two shafts.

The aforementioned support plate 28 carries a part made from plastics material in the form of an internally toothed ring and belonging to the aforementioned gearbox, whose input pinion is fixed to the front end of the shaft of the electric motor.

The planet carrier of the gearbox is fixed to the rear end of the shaft 100.

The rear end of the shaft 101 is mounted for rotation inside a bearing carried by a part, referred to as the rear bearing, closing off the first casing. This first casing carries internally a field winding, here with magnets, surrounding, with an air gap, the armature of the electric motor comprising a rotor in the form of a packet of metal sheets fixed to the shaft of the electric motor, knurled for this purpose.

This packet of sheets is provided with axial grooves for housing electrically conductive elements in the form of bars arranged in networks connected to the electrically conductive bars of a commutator carried by the rear end of the shaft 101.

Brushes, mounted inside cages carried by the rear bearing, are intended to cooperate with the bars of the commutator, here of the frontal type.

A series of these brushes is connected to earth via the first casing and the support 4. A second series of these brushes is connected to a connector receiving a cable connecting the connector to a first contact terminal of the contactor 2 fixed to a cap made from electrically insulating material closing off the open rear end of the second casing having at its front end a base with a hole for the passage of an internally hollow movable core 2b. The cap also carries a second contact terminal and at least one connection for the electrical supply to the winding 2a.

A fixed core 2d is fixedly located at the rear end of the second casing and partly enters inside a support 2c of the winding 2a. The support 2c has a U-shaped cross-section and therefore constitutes a bearing for guiding the core 2b. A first shouldered rod passes through the fixed core 2d and carries a contact plate intended to come into abutment on the aforementioned two contact terminals having contact studs for this purpose.

The second terminal is connected to the positive terminal of the battery. The winding 2a is connected to this positive terminal of the battery via a starting switch operated by the ignition key or any other device. This winding 2a is connected to earth via the second casing and the support 4.

The first rod and the contact plate belong to a moving contact 3 which, in its idle position, is kept pressed against the fixed core by a cutoff spring 19. The cutoff spring acts between the contact plate and the cap provided with a housing for receiving the cutoff spring.

Another spring, referred to as the contact spring 21, with a greater stiffness than the cutoff spring, is located axially between the other face of the contact plate and a shoulder on the rod, passing through the fixed core 2d in order to have an end.

The movable core 2b enters inside the second casing and the winding 2a. This movable core 2b extends in axial projection with respect to the front end, and the second casing. The movable core 2b is subjected to the action of a return spring 18 acting between the base of the second casing and a shoulder fixed to the movable core provided at the centre with a blind hole for the mounting with axial sliding of a second rod shouldered at its rear end for the action of a spring, referred to as a teeth against teeth spring 5, acting between the said shoulder and the base of the movable core. The teeth against teeth spring has a greater stiffness than the return spring 18 and a lesser thickness than the springs associated with the movable contact 3.

The front end of the second rod carries a shaft for the articulated mounting of the top end of a manoeuvring lever 13 for the starter head with pinion 102. This lever 13 is mounted at an intermediate pivoting point 11 carried by a protuberance fixed to the support plate 28, referred to as the base plate. This intermediate point 11 has an axial clearance, referred to as the cutoff clearance JC, which makes it possible to electrically disconnect the electric motor from the starter should the pinion 1 remain meshed in the starting ring C. For models of starter which do not have a base plate, this intermediate point 11 can be carried for example by the support 4 of the starter. The bottom end of the manoeuvring lever comprises two arms or branches mounted in an annular groove produced in the driver 12 so that the manoeuvring lever is in the form of a fork.

More precisely, the groove in the driver is delimited by an axially oriented annular base and by two transversely oriented annular flanks perpendicular to the shaft 100.

The axial difference between the two flanks depends on the thickness of the arms, usually referred to as fingers, of the forks so that these can enter, at least with mounting clearance, in the groove in order to be able to move the driver axially when the contactor is supplied electrically.

As depicted in FIG. 1, the contactor 2, the electric motor M and the starter head are in their idle position. In this position the winding 2a and the electric motor M are not supplied electrically; the aforementioned starting switch being open. The pinion 1 is at an axial distance from the starting ring C of the thermal engine, the movable contact 3 is at a distance from the contact terminals in the form of studs, whilst the core 2b is at an axial distance from the rod of the movable contact.

When the switch is closed by means of the ignition key, the winding 2a is supplied electrically and a magnetic field is created so that the movable core 2b moves axially in the direction of the fixed core 2d and the movable contact and, by means of the manoeuvring fork, moves the starter head and the pinion 1 in the direction of the ring C. The pinion 1 can enter between the teeth of the ring C so that it is in a position of meshing with the ring C. The movement of the pinion 1 is limited by the cooperation of the pinion 1 with a working stop 6 fixed to the shaft 100. The movement of the movable core continuing, the latter comes into abutment against the rod of the movable contact by virtue of a washer which the movable core 2b carries at the rear for this purpose. The cutoff spring is then compressed until the movable contact is closed through contact of its plate with the contact terminals.

The electrical circuit of the electric motor M is then closed so that the latter rotationally drives the shaft 100 and therefore the pinion 1 via the driver and the helical flutes acting between the driver and the shaft 100. The magnetic circuit closes completely after the electrical circuit, the movable core 2b coming into contact with the fixed core 2d after compression of the contact spring. The freewheel is locked when the electric motor turns, the thermal engine not yet being started.

It may happen that the pinion abuts against the ring C without meshing with it. In this case, the teeth against teeth spring 5 is compressed until closure of the movable contact and supply of the electric motor, which then rotationally drives the shaft 100 with penetration of the teeth on the pinion 1 into the teeth of the ring C. When the thermal engine has started, the freewheel enables the pinion to turn with respect to the shaft 100 and therefore to save wear on the motor M.

The movable core 2b and the teeth against teeth spring 5 increase the radial size of the contactor, which must be powerful.

This method of penetration of the pinion 1 of the starter head 102 has the following drawbacks:

the kinematics, which is an intrinsic characteristic of the starter, expresses the forward movement of the starter head in millimetres between the moment the ignition key is turned until the moment when the electric motor is powered. This kinematics must be greater than the distance which exists at rest between the starter head and the ring C, otherwise the electric motor could be powered even before the pinion 1 of the starter head has penetrated the ring C of the thermal engine, thus causing this same ring to be milled by the starter head. This kinematics depends on the power of the solenoid, comprising the winding 2a, on the weight of the starter head, on the stiffness of the various springs present in the system, on the viscosity of the greases, on the friction existing between the various moving parts and on the temperature. The kinematics is difficult to optimise given the large number of parameters influencing it.

the stiffness of the teeth against teeth spring 5 must be sufficient to push the pinion of the starter head 102 into the ring 3 by a sufficient length when the pinion 1 is no longer in a tooth against tooth position. On the other hand, this stiffness must not be too high since it is a component of the sizing of the power of the solenoid 2a. The greater the stiffness of the tooth against tooth spring 5, the greater the electromagnetic field that must be created by the solenoid. The size of the solenoid 2a is all the greater, the greater the magnetic field that it must create. The power of the solenoid thus depends on the weight of the starter head 102 and the stiffness of the tooth against tooth spring 5. The more powerful the solenoid, the weaker the kinematics. This is because a powerful solenoid is capable of overcoming the force of the tooth against tooth spring so as to achieve the power contact whilst the starter head will be practically unmoved because of its inertia. Sizing the solenoid is therefore not easy and takes a large amount of development time. It is also necessary to adapt the solenoid to the starter heads which it must set in movement, which results in a lack of standardisation.

the power necessary for setting in movement the smallest of the starter heads is such that the volume of the solenoid 2a is large. In general terms, the diameter of the solenoid is around 50 mm for a length dependent to the maximum on that of the starter.

in the tooth against tooth position, the electric motor is powered before the pinion 1 of the starter head has penetrated the ring C. If the surface finishes of the starting ring C of the thermal engine or of the pinion 1 are degraded, if the stiffness of the tooth against tooth spring is too low, if the electric motor has too great an acceleration at the start, which is often the case with starters without a gearbox, there is a risk of not having the starter head penetrate sufficiently into the ring C and thus putting the pinion 1 in rotation in front of the ring C at high speed, that is to say causing milling of this ring by the pinion 1 of the starter head, thus causing irreversible damage.

when the starter head arrives in abutment against the ring C whilst being launched by the fork 13 moved by the movable core 2b, it has a not insignificant speed and the impact is great. This generates noise and causes damage to the surfaces in contact. This damage on starting may be a cause of milling.

The document FR A 2,174,421 discloses a double-contact solution in order to generate a pre-rotation of the electric motor. The system is provided with a solenoid and comprises a coil connected electrically on the one hand to the switch actuated by the ignition key and to a fixed contact positioned on the fixed core of the solenoid and on the other hand, via the contact plate of the movable contact, to a second fixed contact disposed diametrically opposite to the first contact on the fixed core and itself electrically connected directly to the electric motor. In the nominal idle position, the contact plate rests on the aforementioned two contacts so that, when the switch is closed by actuating the ignition key, the energising of the electric motor is effected by passing a current through contacts via the plate and an electrical resistance. The electric motor commences a pre-rotation at low speed whilst the movable core is set in movement under the action of the magnetic field created by the coil. After engagement of the pinion in the ring C, the movable core, when it moves, comes into contact with a spring, an independent part distant from the movable core by a length calculated so that there is contact between the two parts solely when the piston meshes with the ring. The contact plate, secured and subjected to the action of the spring, begins to move, and is disconnected from the first two contacts, cutting off the power supply to the electric motor. At the end of the translation movement of the movable core, the plate comes into contact with two other contacts which enable closure of the power circuit and supply the electric motor under full load. The drawbacks of this principle are of two types. First of all, the break in the electrical supply to the electric motor when the contact plate moves and then next the level of the current (approximately 70 A) which passes through the first two contacts, the coil and the switch actuated by the ignition key in order to effect the pre-rotation of the electric motor. This value of current is not acceptable at the switch, because the maximum permitted value is around 50 A.

The patent U.S. Pat. No. 4,418,289 shows a solution with a dual-stage contactor similar to the solution in the document FR A 2,174,421. This solution involves two contact plates coming into contact with two series of contacts. The electrical diagram is identical except that the resistive coil is in this case a pure resistance placed outside the solenoid. The two plates are not returned simultaneously when the contactor solenoid is deactivated by the ignition key.

The patent U.S. Pat. No. 5,814,896 presents a solution in which the contactor is coaxial with the body of the starter and is placed at the rear of the apparatus. The dual-contact system is provided by a single-contact plate placed on a movable shaft fixed to the movable core, which is actuated by a cable running the entire length of the electric motor and connected to the starter head. The second contact is implemented by a movable contact connected to a spring of the “clothes peg” type, the other end of which is connected to the movable shaft. This contact comes into contact with the battery terminal in the same way as the contact plate. The drawback of this solution consists of the sequential breaking of the two power circuits.

The document U.S. Pat. No. 2,342,632 discloses a starter in which there is provided a rotational locking of the pinion of the starter head in order to make it move towards the starting ring of the thermal engine by screwing the driver onto the helical teeth carried by the shaft which carries the pinion of the starter head. The rotational locking is achieved by means of a needle manoeuvred by a solenoid perpendicular to the driver. This embodiment is bulky radially.

These solutions give satisfaction, but nevertheless the applicant wondered whether it was still possible to reduce further the electromagnetic power of the contactor in order to reduce its external diameter still further.

### OBJECT OF THE INVENTION

In order to remedy these drawbacks, the invention proposes a starter for a motor vehicle with a thermal engine and a starting ring of the thermal engine, comprising a starter head, provided with a driver and a pinion, able to pass from a retracted idle position to an advanced position of meshing with the starting ring of the motor vehicle thermal engine, an electric motor provided with a shaft able to drive a starter-head shaft associated with the starter head, complementary helical flutes acting locally between the internal periphery of the driver and the external periphery of the starter-head shaft, an electromagnetic contactor extending parallel to the electric motor above it and comprising a movable core, a fork mounted for articulation at its top end on the movable core and at an intermediate point on a support of the electric motor and contactor, in which the driver comprises a groove for receiving the bottom end of the fork delimited by two flanks and in which means are provided for making the electric motor turn at a slow speed in a first phase and then at full power, characterised in that the starter head is rotationally locked by means of cooperation between the fork and the driver for its passage from its idle position to its position of meshing with the starting ring.

Thus, by virtue of the rotational locking of the starter head and these means, it is possible to reduce the power of the electromagnetic contactor and its radial size still further, by virtue of additional power in the electric motor.

Advantage is also taken of the space existing between the flanks of the groove, which makes it possible not to increase the axial size overmuch.

In addition the fork becomes a mainly following fork.

According to other characteristics of the invention:

the said means are means of locking in rotation with cooperation of shapes;

the said means are means of locking in rotation of the friction type;

when the contactor is supplied electrically, the fork cooperates with the flank, referred to as the front flank of the fork reception groove; the said front being provided with circumferential corrugations;

the fork has arms with corrugations of complementary shape to those on the front flank;

the said means are of the ratchet tooth type;

the front flank of the reception groove of the fork comprises notches and protrusions, whilst the fork has projecting fingers cooperating with the notches for the rotational locking of the starter head;

the front flank of the fork reception groove cooperates with a ring on the fork mounted so as to slide axially on the barrel of the driver;

the ring is mounted for articulation on the body of the fork and is actuated by the body of the fork;

the fork has at its end which cooperates with the groove of the driver at least one shoe which cooperates with a rim situated at the periphery of the driver when the starter head meshes with the starting ring of the motor vehicle engine;

the said means are disengageable;

the support has a front part made from sheet metal roughly in the shape of an ogive;

the front part is connected to a fixing and centring flange;

the sheet-metal support is obtained by deformation of material, such as pressing, and the flange is made in a single piece with the front part;

the electric motor and contactor each have a casing fixed to the other casing;

the two casings belong to one and the same piece;

the casing or two casings are closed on the opposite side to the support by a common piece forming the rear bearing of the electric motor;

the means provided for making the electric motor turn in pre-rotation and then at full power comprise two plates carried by the movable core, the first plate, used during pre-rotation, is connected to two contacts, the first contact is connected to the resistive coil, the second contact is connected to the positive terminal of the battery, and then, during full power, the second plate is connected to two contacts, the third contact is connected to the resistive coil and to the electric motor, and the fourth contact is connected to the positive terminal of the battery;

a contact plate is allowed to rock about the second fixed contact in order to cooperate with another fixed contact offset axially and connected to the positive terminal of the battery in order to supply the electric motor;

the movable shaft comprises a blade provided with a local protrusion which drives the contact plates when the movable shaft returns after opening of the control circuit;

the electromagnetic contactor comprises at least one plate able to rotate about the movable shaft for putting the electric motor in pre-rotation and then at full power;

the plate has two electrically connected studs, a first stud continuously electrically connected with a contact connected to the battery voltage, a second stud connected to a contact when the motor is pre-rotated, this second stud then coming into contact with a third contact, after rotation of the said plate, in order to provide full power to the starter, the second and third contacts being connected together by the pre-rotation resistive coil, the contact being connected to the electric motor;

the pinion of the starter head is connected to the driver by a device for coupling to the conical clutch;

the casing or casings are attached by crimping to the support;

the pre-rotation is effected by supplying sufficient electric current to the electric motor by means of the attraction coil without using any resistive element such as a pre-rotation resistive coil. In this case, the fork is used for the rotational locking of the starter head and advantageously for helping the starter head to be directed towards the starting ring of the thermal engine.

### SUMMARY DESCRIPTION OF THE DRAWINGS

The following description illustrates the invention with regard to the accompanying drawings, in which:

FIG. 1 is a view in axial section of a starter of the prior art;

FIG. 2 is a diagram of the supply circuit for the electric motor of the starter according to the invention;

FIG. 3 is a view similar to FIG. 1 for a first example embodiment according to the invention;

FIG. 4 is a view similar to FIG. 3 for a second example embodiment according to the invention;

FIG. 5 is a perspective view of the starter support of FIGS. 3 and 4;

FIG. 6 is a perspective view of a single casing equipping the starters of FIGS. 3 and 4;

FIGS. 7a, 7b are perspective views, at different angles, of a starter equipped with a support and a single casing of FIG. 6;

FIGS. 8 and 9 are partial views in section showing the assembly of the support or rear bearing with the single casing for two embodiments;

FIG. 10 is a local view of the rear bearing assembled with the single casing for a third example of an assembly of the rear bearing with the single assembly casing of FIG. 6;

FIG. 11 is a partial view in axial section of the embodiment in FIG. 10;

FIG. 12 is a view in section along the line 12-12 in FIG. 10;

FIG. 13 is a view similar to FIG. 10 for a fourth method of assembling the rear bearing with the single casing;

FIG. 14 is a partial view in axial section for a fifth method of assembling the rear bearing with the single casing;

FIGS. 15 and 16 are views similar to FIG. 13 for sixth and seventh methods of assembling the single casing with the rear bearing;

FIG. 17 is a view in section for an eighth method of assembling the single casing with the rear bearing;

FIG. 18 is a plan view of FIG. 17;

FIG. 19 is a view in axial section for a ninth method of assembling the rear bearing with the single casing;

FIGS. 20, 21, 23 are views similar to FIG. 19 for respectively a tenth, eleventh and twelfth method of assembling the single casing with the rear bearing;

FIGS. 22 and 24 are views in the direction of the arrows 22 and 24 in FIG. 23;

FIG. 25 is a schematic view of an embodiment of a starter head associated with the contactor according to the invention;

FIGS. 26 and 27 are two views in axial section of two variant embodiments of FIG. 25;

FIG. 28 is a front view of the elastic washer equipping the starter head in FIGS. 26 and 27;

FIGS. 29 and 30 each illustrate in perspective an embodiment of the fork according to the invention;

FIGS. 31 and 32 each illustrate in perspective an embodiment of the driver comprising means for locking in rotation;

FIG. 33 is a view of a starter comprising a device for the rotational locking of its driver associated with a ring;

FIG. 34 is a partial view in section of a relay comprising a rocking plate;

FIGS. 35 and 36 are two views, respectively in axial section and front view, presenting a relay comprising a rotating plate;

FIG. 37 is a complete view in section of an electromagnetic contactor according to one embodiment of the invention;

FIGS. 38a to 38c depict example embodiments of the means of locking in rotation;

FIGS. 39 and 40 illustrate, respectively in axial section and schematically, other embodiments of the pre-rotation according to the invention.

### DESCRIPTION OF PREFERENTIAL EMBODIMENTS

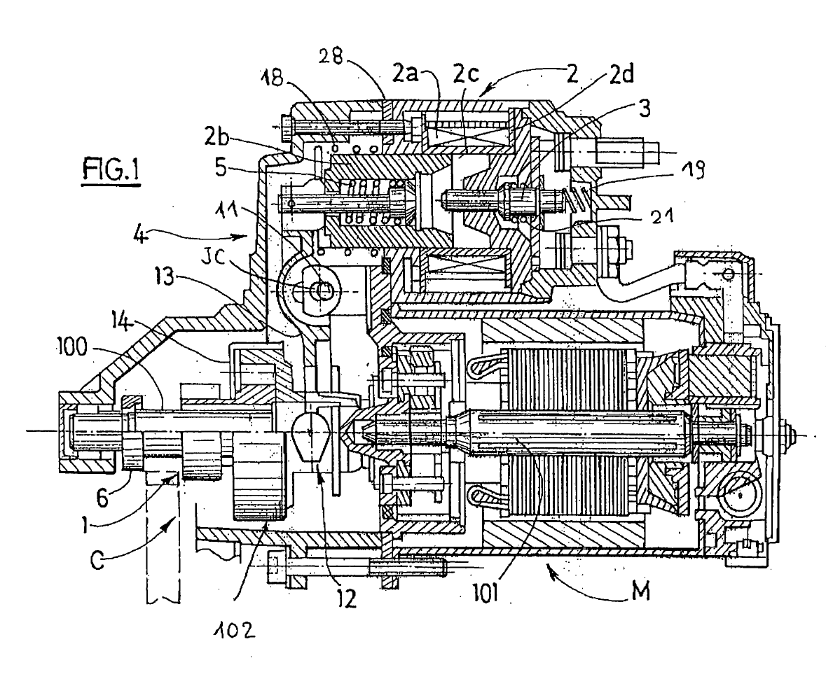

In the figures illustrated, the common elements will be allocated the same reference signs and the direction front to rear corresponds to the direction going from the left-hand part to the right-hand part in FIGS. 1, 3 and 4.

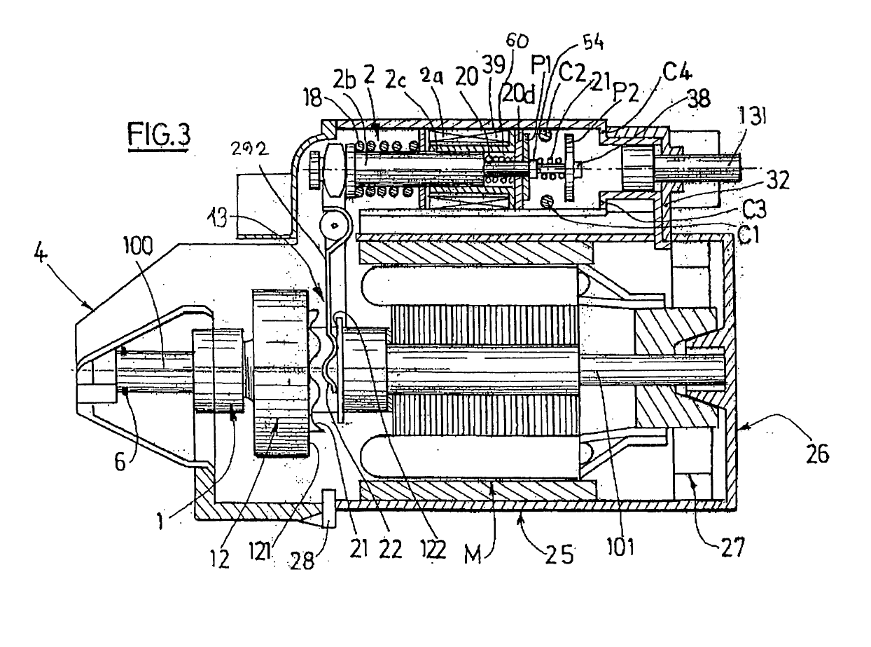

In FIGS. 3 and 4 the starter comprises, as in FIG. 1, a support 4 which comprises first means of fixing and centring the electromagnetic contactor, and second means of fixing and centring the electric motor M extending parallel to the contactor and below it. The support 4 also comprises third means of fixing and centring the starter on the crankcase of the thermal engine of the motor vehicle so that the pinion 1 of the starter head meshes reliably with the starting ring C of the thermal engine; the said ring belonging here to a flywheel rigidly or elastically fixed with respect to rotation to the crankshaft of the thermal engine or internal combustion engine.

The support 4 is metallic and provides the earth return. It is economical since it is here obtained by deformation of material, for example by pressing.

The electric motor M has a constitution similar to that in FIG. 1 except with regard to the mounting of the brushes and the bar commutator.

Here the brushes are radially oriented and are carried internally by the metallic casing 25 of the electric motor and the commutator is axially oriented. Four brushes are provided here. Two brushes, referred to as negative brushes, are connected to earth via the casing 25 and the support 4. Two brushes referred to as positive brushes are connected to the positive terminal of the battery via the contactor 2.

These figures depict schematically at 25 a brush/cage assembly.

Here the shaft 101 of the electric motor also constitutes the shaft 100 of the starter head and therefore carries the working stop 6.

The rear bearing 26 is made from plastics material and, according to one characteristic, also constitutes the rear bearing of the contactor. The casings of the contactor 2 and of the electric motor M are fixed to each other. Advantageously the two casings belong to one and the same continuous piece 25, as can be seen in FIG. 6.

The connecting cable between the contactor and the positive brushes is omitted as described below. The starter is thus less expensive since it comprises fewer components.

The fork 13 is, as in FIG. 1, mounted for articulation at an intermediate point 11 on the support 4. The fork 13 is mounted for articulation at its top end directly on the movable core 2b of the contactor 2 and at its bottom end, as in FIG. 1, enters a groove in the driver 12 belonging to the starter head with pinion 102.

According to one characteristic of the invention, a starter of the type indicated above is characterised in that the driver 12 is provided with means for locking it in rotation when it passes from its idle position to its position of meshing with the starting ring.

According to a first embodiment, as depicted in FIGS. 3 and 4, the locking in rotation is effected by a fork 13 preferably produced from rigid material. A device for locking in rotation therefore acts between the starter head and the fork.

Thus according to the invention the starter head is locked in rotation by means of cooperation between the fork 13 and the driver 12 for its passage from its idle position (FIGS. 3 and 4) to its position of meshing via its pinion, with the starting ring.

These cooperation means, which in FIGS. 3 and 4 are means of locking in rotation with cooperation of shapes, are located at the fingers situated at the base of the fork 13 and at the rear face of the driver 12. More precisely, the branches or arms of the fork are received in a groove in the driver 12 delimited by the flanks 121, 122, respectively front and rear, transverse with respect to the axis of the shaft 101.

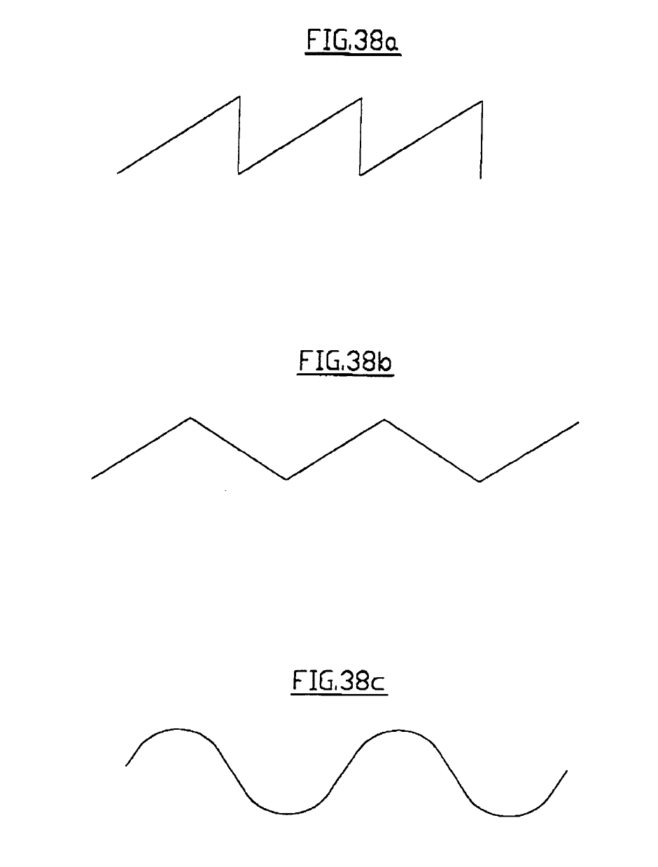

In the idle state the fingers of the fork 13 are in abutment on the smooth rear flank 122 of the reception groove. The branches of the fork are corrugated in order to form fingers, as can be seen at 22. The front flank 121 has, for receiving the fingers 22, circumferential corrugations 21 as depicted in FIGS. 3 and 38c. In a variant, the front flank 121 can have other means with cooperation of shapes, for example in the form of saw teeth (FIG. 38a), ratchet teeth (FIG. 38b) or corrugated (FIG. 38c); the branches of the fork having means complementary to those of the flank 121. In general terms the fork cooperates with the flank 121 and has branches with corrugations with a shape complementary to that of the flank 121.

In another embodiment, the means of locking in rotation can consist of flat friction areas disposed on the one hand on the driver and on the other hand on the fork.

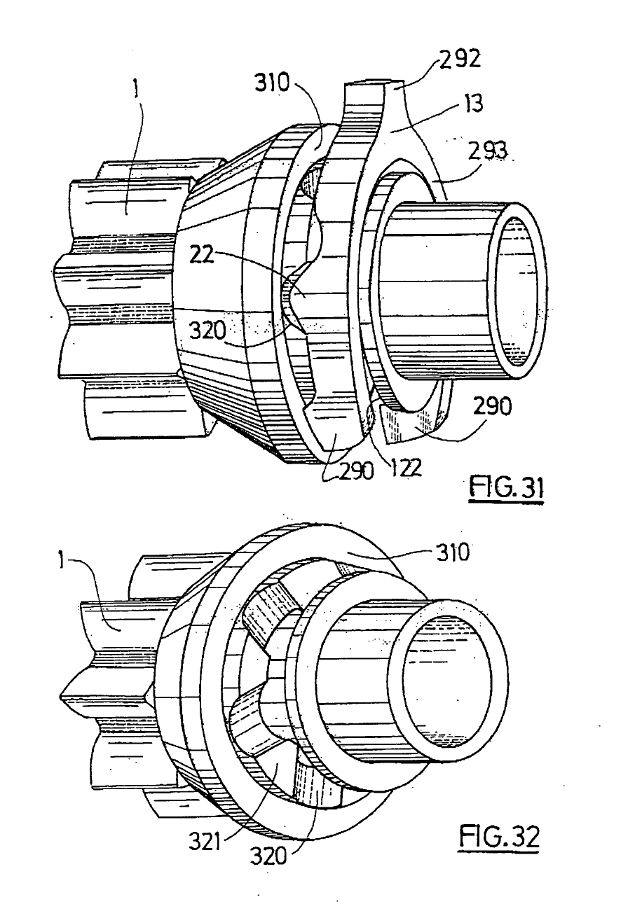

In a variant, as illustrated in FIGS. 31 and 32, the circumferential corrugations 21 are formed by notches 320 and protrusions 321. The notches 320 have shapes complementary to those of the fingers 22 of the branches 293 of the fork 13, as depicted in FIG. 31. The projecting fingers 22 enter the notches 320.

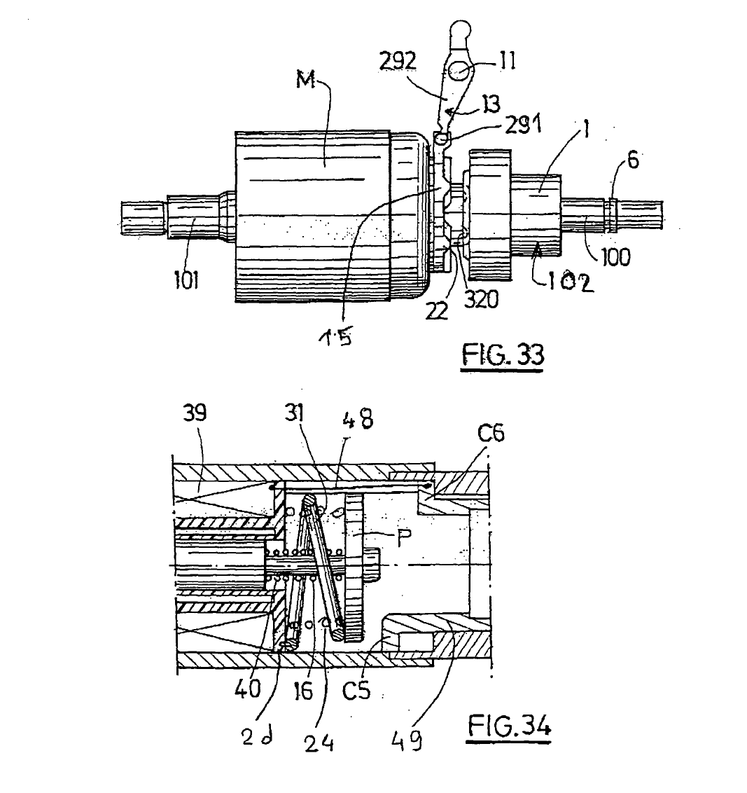

FIG. 33 illustrates a variant of the device for locking the starter head in rotation. In this embodiment the internal periphery of the fork comprises a ring and the fingers 22 of the fork 13 are offset on the ring 15 mounted so as slide axially on the barrel-shaped tubular portion of the driver. This ring 13 is mounted for articulation on the internal end of the rod-shaped body 292 of the fork by means of a pivoting means 291 comprising for example a pivot carried by the rod 292 and received in a fork joint on the ring 15. The ring 15 is actuated by the body 292 of the fork for its axial movement on the barrel of the driver. In a variant, the pivoting means has a clearance JC (not shown) fulfilling the function of the cutoff clearance described above.

In this embodiment, the fork 13 therefore does not have any arms but rather a rod 292 comprising at its bottom end the means 291 of pivoting with the ring 15.

This embodiment of a device for locking in rotation carried by a ring 15 has the advantage of having a perfect connection between the ring 15 and the driver throughout the translation of the starter head, which is not the case with the fork which pivots about its axis, thus encouraging the teeth on the fork to emerge from the notches in the driver.

In a variant, a device with a pawl and ratchet wheel can be envisaged.

In general terms, the locking in rotation of the starter head is achieved by friction, by means of magnets, by cooperation of shapes or by any other means.

Obviously the shapes which cooperate with each other are not limited to the example embodiments described above.

Thus according to the invention the locking in rotation of the starter head consists of means which cooperate together rigidly. This is because the device for locking in rotation (ratchet teeth, friction, magnets etc), the fork and the rod of the movable shaft are parts made from rigid materials which cannot exhibit a deformation of material under the effect of the force exerted by the attraction of the movable core.

One advantage of the invention is to achieve a locking in rotation with a reduced number of components, these components mainly being components known in the field of starters, in particular the fork, the movable shaft and the groove of the driver in which the fingers of the fork are housed.

Thus, in a simple and economical manner, a locking in rotation is achieved which makes it possible to obtain an electromagnetic contactor of reduced size, in particular with regard to the movable core, since the force which makes it possible to make the starter head move forwards is supplied by the electric motor in its pre-rotation mode.

The force exerted by the fork on the starter head is very much reduced. It will be appreciated that the movable core is simplified.

In order to put the electric motor M in pre-rotation before applying full power to it, the relay consisting of the electromagnetic contactor must comprise a device which makes it possible on the one hand to implement the pre-rotation of the electric motor under low power and then to apply full power to this same motor and on the other hand, when the ignition key opens, to simultaneously deactivate the full power and the pre-rotation of the electric motor. It is important to be able to deactivate these two operating modes simultaneously, in particular in the case where the pinion remains locked in the starting ring. In this case, the device according to the invention must make it possible, by means of the cutoff clearance JC, to disconnect full power simultaneously with the pre-rotation in order to completely deactivate the electric motor M.

In a first embodiment, the means for making the electric motor rotate at slow speed and then at full power comprise two contact plates mounted on a movable shaft fixed to the movable core and two pairs of contacts.

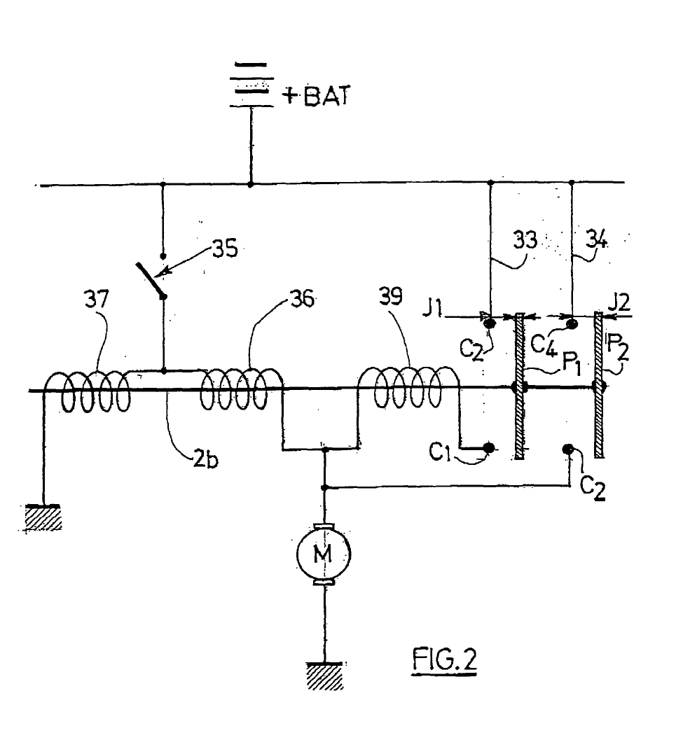

FIG. 2 depicts schematically the electrical circuit of the starter. This comprises a holding winding 37, an attraction winding 36, an attraction and pre-rotation coil 39, two electrically conductive contact plates P1 and P2 intended to come respectively into contact with a first series of contacts comprising two contacts C1 and C2 and with a second series of contacts comprising two contacts C3 and C4, the electric motor M and the starting switch 35 electrically connected to the positive terminal of the battery. The electric motor M and the holding winding 37 are electrically connected to earth, whilst the contacts C2 and C4 are electrically connected, respectively by lines 33 and 34, to the positive terminal of the battery. The attraction 36 and holding 37 coils surround the movable core 2b. Advantageously, the pre-rotation coil 39 also surrounds the movable core 2b. This pre-rotation coil 39 is advantageously electrically connected to the contact C1 of the first series of contacts and to the electric motor M whilst the contact C3 is electrically connected to the electric motor.

The plates P1 and P2 are carried by the movable core 2b of FIG. 3. In this FIG. 3 the winding 2a comprises the windings 37 and 36 of FIG. 2 connected in series with the coil 39 in the form of an electrical resistance.

By virtue of this arrangement, the switch 35 being closed, the motor rotates at slow speed as soon as the first switch consisting of the first plate P1 and the first series of contacts C1, C2 closes.

The movement of the movable core continuing, the second contact plate P2 comes into contact with the second series of contacts C3, C4, one of which is connected electrically to the electric motor and the other electrically to the positive terminal of the battery so that the electric motor turns at full power.

Clearances J1 and J2 are calculated so that the first contact of the plate P1 with the contacts C1, C2 takes place when the cutoff clearance JC is taken up by the movable core and the second contact of the plate P2 with the contacts C3, C4 takes place when the movable core is situated, with respect to the fixed pinion 2d (FIG. 3), almost at zero air gap, which ensures good entry of the pinion into the starting ring.

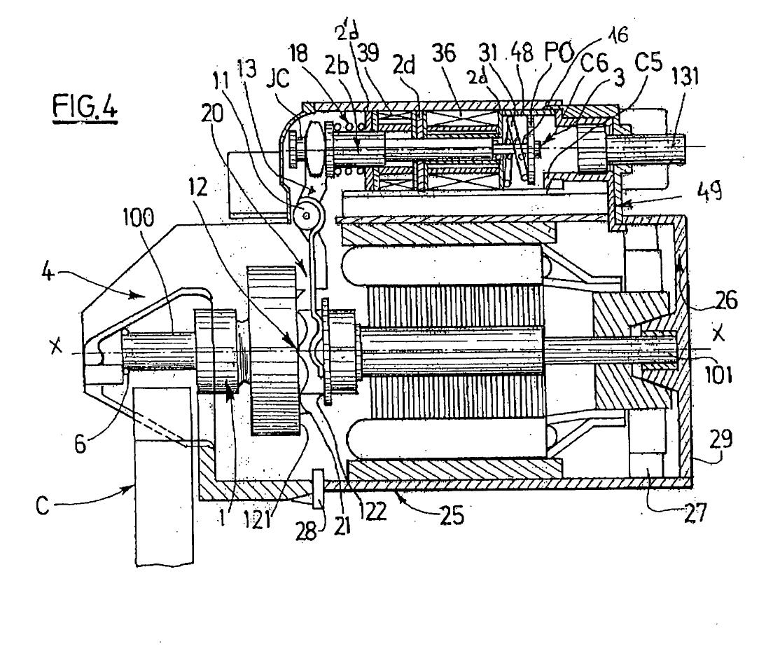

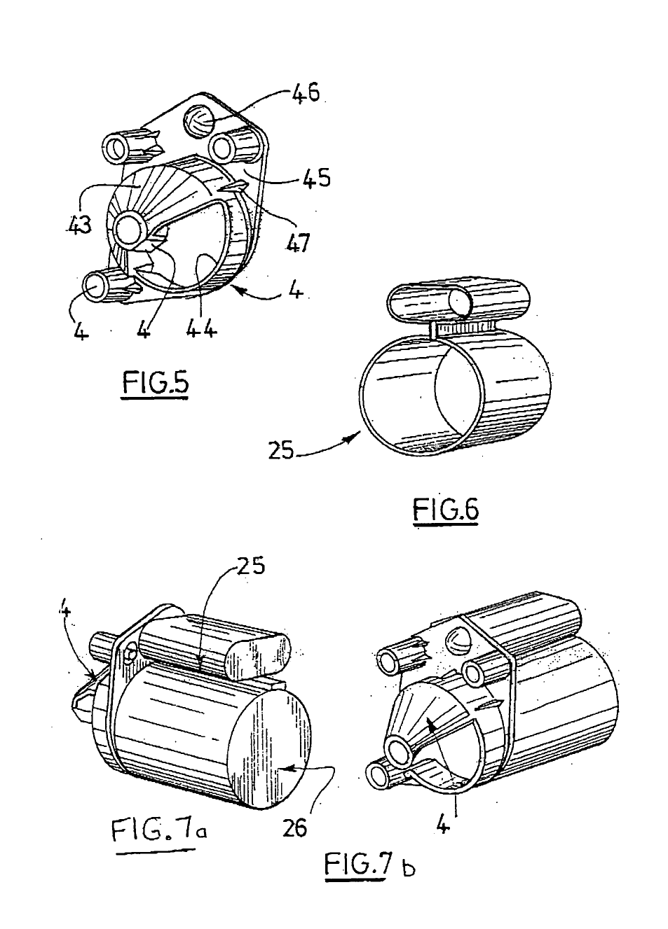

The return of the plates when the control circuit of the motor M and the relay consisting of the electromagnetic contactor open must take place simultaneously in order to not leave the armature under voltage, even at a low current. For this purpose, as depicted in FIG. 7, a clip is used for the first contact plate. This clip is produced by producing in the movable shaft 40, by means of a removal of material in this shaft, a blade 23 provided with a local protrusion. When the movable shaft advances, the contact plate P1 comes into contact with the contacts C1 and C2. It locks whilst the movable shaft continues its axial travel towards the rear. The protrusion on the blade 23 arrives at the level of the plate P1. The blade 23 drops, allowing the plate P1 to pass, which then passes over the protrusion here located at the middle of the tongue, and then rises afterwards. The clip is then in position for functioning.

On return, that is to say when the movable shaft is directed forwards, the protrusion comes to abut against the plate P1. The axial force to be supplied in order once again to make the blade 23 fold being greater than the force supplied by the contact spring 20 of the plate, the said plate is forced to follow the movement of the movable shaft forwards and therefore electrically disconnects the contacts C1 and C2. The plate then comes to abut against the fixed core 2d of the solenoid and, the force exerted by the return spring 17, 18 of the movable core being greater than the disengagement force, the blade drops and the protrusion once again passes on the other side of the plate into its nominal idle position. Advantageously this clip makes it possible to electrically disconnect the electric motor, in particular at slow pre-rotation speed, in the case where the pinion remains locked in the starting ring C of the internal combustion engine. This is possible by virtue of the cutoff clearance JC, which allows a forward movement of the movable shaft even if the pinion remains meshed in the starting ring.

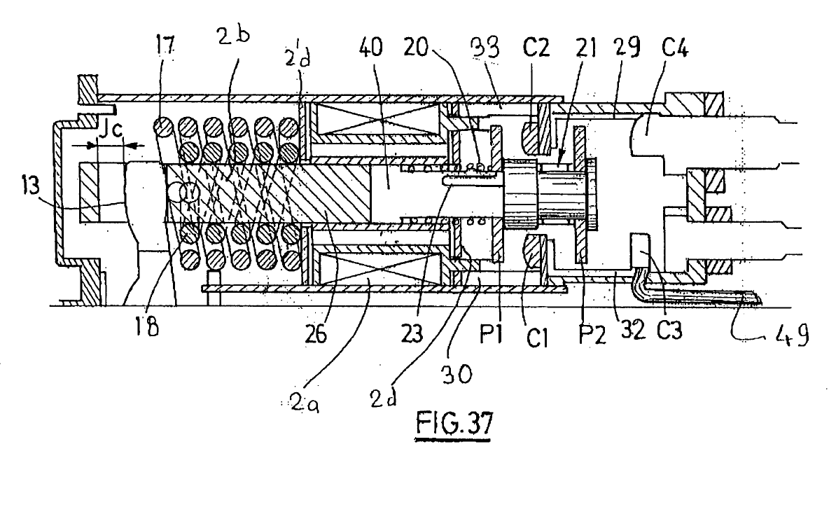

FIG. 3 illustrates a starter comprising a contactor provided with two contact plates P1 and P2 as described above. In this embodiment, the movable core 2b is stepped in diameter and comprises a portion with the largest diameter projecting out of the winding 2a. This core, like the one in FIG. 37, is simplified compared with the one in FIG. 1 and consists of a simple economical stepped rod of reduced radial size guided by the support 2 of the coil 2a forming a solenoid.

A return spring 18 acts between the support of the winding and a shoulder on the front part of the core 2b. This spring replaces the return spring 28 of FIG. 1. The first largest-diameter portion enters inside the winding 2a and is extended by a second portion with a smaller diameter around which there is mounted a contact spring 20 for a plate P1 bearing on the change in diameter between the first and second portions of the movable core and on the first electrically conductive contact plate P1 axially fixed to an attached stop 54, such as a circlip, mounted at the rear end of the second portion extended by a third portion, with a smaller diameter than the second portion, around which there is mounted a contact spring 21 in abutment on the stop 54 and on the second plate P2 axially fixed to an end stop 38 attached to the rear end of the movable core. The electrically conductive plates can therefore move relatively with respect to the core 2b. In particular, the plate P1, axially fixed against the stop 54, is pushed backwards under the action of the spring 20 which is axially fixed towards the front against a shoulder on the movable core. Thus, when the movable core moves backwards, the plate P1 moves towards the rear, under the effect of the contact spring 20, until it arrives in abutment against the contacts C1 and C2. A recess 60 is provided in the fixed core 2d to allow passage of the contact spring 20 of the first plate P1.

Thus, when the plate P1 is in contact with the contacts C1, C2, the core 2b moves axially whilst compressing the spring 20. The same applies to the plate P2, the contact spring 21 being compressed under the action of the backward movement of the stepped movable core. After the switch 35 associated with the ignition key opens, the springs 21, 20 and 18 exert a continuous action.

The screw 131 is connected to the positive terminal of the battery and is in electrical connection with an electrical track having a perpendicular return constituting the contact C2. Likewise the contact C1 belongs to an electrical track connected to the positive brushes of the electric motor M.

The presence (not visible) of a screw situated in the same horizontal plane as the screw 131 connected on the one hand to the switch (ignition key) and on the other hand to the winding of the contactor should be noted.

The contact C3 also belongs to an electrical track connected to the positive brushes, and the contact C2 is electrically connected on the one hand to an electrical resistance to make the electric motor turn at slow speed initially and on the other hand to the contact C4 connected to the positive terminal of the battery.

FIG. 37 illustrates with more precision a complete relay including an electromagnetic contactor comprising two plates. In this example embodiment, two contact plates P1 and P2 are fixed to a plastic movable shaft 40 on which they are able to move in translation. This movable shaft 40 is for example fixed by clipping or gluing or welding to the movable core 2b. This movable core can have a cylindrical or square cross-section. In the case of a square cross-section, the movable core in produced in an economical manner from a stack of metal sheets. Springs 20 and 21 hold the plates against shoulders produced in the shaft. The plates have cylindrical central openings with a diameter equivalent to that of the shoulders in order to make mounting possible. Then they are fixed by deformation of the opening which along one axis reduces the diameter, making the opening oblong in shape. Flats formed in the shaft make this deformation possible.

The movable shaft is fixed to the movable core and the assembly can move in translation along the longitudinal axis of the contactor forming a relay. A core return spring 18 is positioned at the front between a shoulder integral with the movable core 2b and a washer 2′d fixed to the support of the winding 2a. It makes it possible to return the movable core to its idle position and to maintain it in this position after the control circuit of the relay is broken. The fork is positioned between two flanks of the movable core. It is, at rest, in abutment on one of the flanks and distant from the second flank by a distance referred to as the cutoff clearance JC.

Positioned between the fork and the washer 2′d, the lever spring 17 makes it possible on the one hand to return the fork to its idle position after the control circuit is broken and on the other hand to keep the starter head in the idle position. The springs 17 and 18 are separate since the spring 17 has a greater stiffness because the starter head can exert a strong thrust on the fork during abrupt decelerations of the vehicle. It is possible to put a stiffness on the spring 18 equivalent to that of the spring 17 since the winding is not initially sized to counter the axial force created by the spring 17 on the fork. The springs 17, 18 allow, in the aforementioned manner, a disengagement of the plate P1.

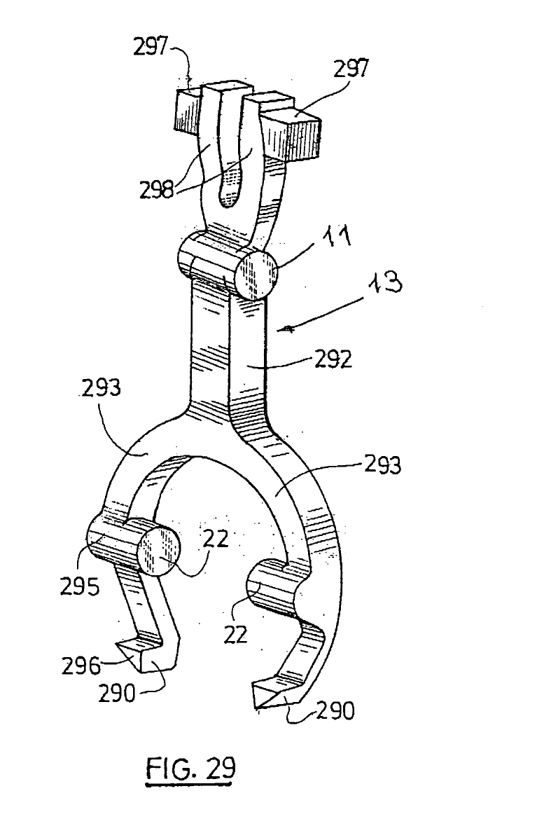

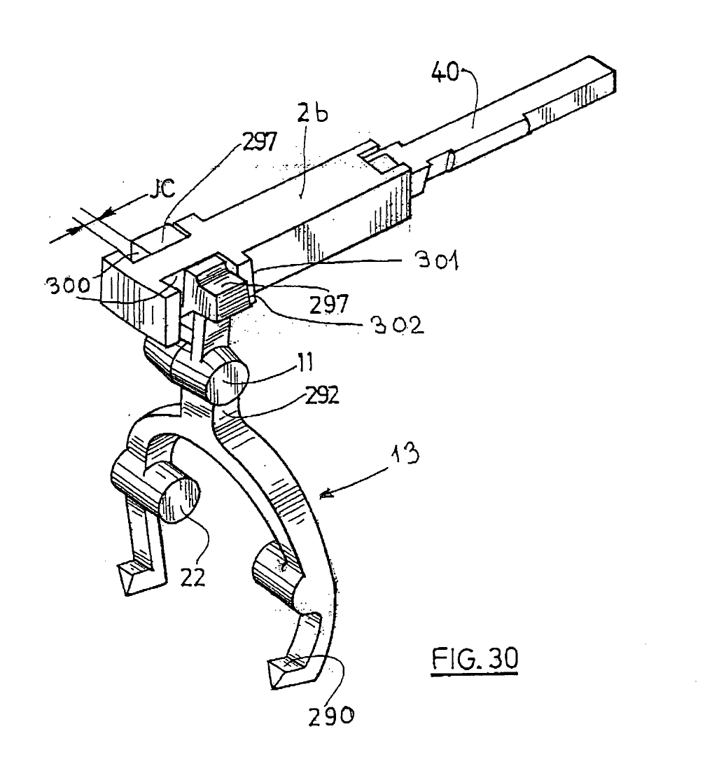

As can be seen in FIG. 29, the fork 13, here made from rigid plastics material or in a variant metallic, below its axis of rotation 11 separates into two branches 293 like a fork. The two ends of this fork have fingers 22 which have a particular shape, here cylindrical, and which can fit in the complementary shape 21 situated on the external face of the driver. These shapes, disposed on the driver, can be assimilated to notches whose purpose is, when the fork is fitted in the driver, to lock the starter head with respect to rotation. On the other hand, if the starter head has the necessary torque, the driver can jump out of the notches, making the fork withdraw.

In FIG. 37, in the aforementioned manner, a blade 23 provided with a protrusion is created on the movable shaft in order to fulfil a clip function with the plate P1 which will make it possible, when the control circuit opens, to return the two plates P1 and P2 at the same time.

The double contact is achieved firstly through the contact of the plate P1 with the contacts C1 and C2 and secondly through contact of the plate P2 with the contacts C3 and C4. The springs 20 and 21 serving respectively as compression springs for the plates in order to ensure a good contact.

The contact C4 is connected to the battery terminal and is connected to the contact C2 by means of an electrical connection 29 of the wire type. The contact C1 is electrically connected to the pre-rotation resistive coil by an electrical connection means 30. The contact C1 is electrically connected to the contact C3 by an electrical connection means 32. The contact C3 is also connected to the electric motor by a connecting means 49.

The contacts C1 and C2 are electrically connected to the pre-rotation resistive coil with a resistance of around 150 mohms in order to limit the passage of the current to a value of between 50 and 80 A, guaranteeing sufficient pre-rotation of the electric motor.

This pre-rotation resistive coil is placed over the other two coils, which are conventionally encountered in all contactors, namely the attraction 36 and holding 37 coils.

In a second embodiment visible in FIG. 34, only one plate P0 is used as well as a single pair of contacts C5 and C6 which are offset axially with respect to each other along the axis of the relay. The contact C5 provides the pre-rotation of the electric motor M and the contact C6 supplies this same motor at full power. The contact C6 is connected to the battery. In one example embodiment, the pre-rotation resistive coil 39 is connected to C6 by means of an electrical connection 48, for example of the wire type. Advantageously, the contact C5 is connected directly to the electric motor by an electrical connection means 49. This embodiment has the advantage of not using external connection terminals and an external connection wire. This avoids problems of watertightness at the external terminals and also helps to reduce the size of the starter and its cost and weight.

The contact plate in a first phase is perpendicular to the movable core and moves in contact with a contact connected to the resistance until it comes into contact with the contact connected to the positive terminal of the battery via the starter switch.

The resistive coil 39, serving here also an attraction coil, is electrically connected to the contact plate P0 by an electrical connection means 31 which is for example welded to the plate P0. This connection means 31 can consist of a wire coming directly from the winding 39. In a variant this connection means 31 can consist of a spring pressed on the circumference of the plate P0.

When the winding 39 of the solenoid is energised, the movable core 2b is attracted and the movable shaft 40 is set in motion. The contact plate P0 touches the contact C5, thus closing the supply circuit of the armature at low current in order to effect a pre-rotation of the electric motor.

The movable core 2b continues its travel and the movable shaft 40, by means of the contact spring 16 of the plate, bears on the plate P0, which pivots about the contact C5. When the movable core 2b has almost arrived at the end of its travel, the plate P0 comes into contact with the contact C6, closing the power circuit and short-circuiting the pre-rotation circuit.

The same clipping system as the one used in the previous solution by virtue of a blade (not shown) makes it possible to open the two power circuits simultaneously when the movable core returns to its idle position.

FIG. 4 illustrates a starter comprising a contactor provided with a pivoting contact plate P0 as described above. In this embodiment, the pre-rotation resistance is here in the form of a resistive coil 39 wound alongside the attraction winding 2a of the movable core 2b.

In this embodiment, the resistive coil 39 surrounds the first large-diameter portion of the movable core whilst the second smaller-diameter section of the movable core is surrounded by the holding and attraction winding 2a. In another embodiment the reverse configuration can be produced.

The second portion of the movable core 2b is longer whilst having no spring, whilst the first portion of this core is shorter and is surrounded by a return spring 18.

The third portion is surrounded by a spring 16 acting on the plate P0, which is here the only one, and a third spring 24 (visible in FIG. 34) acts between the external periphery of the plate and the fixed core 2d of the coil 2a.

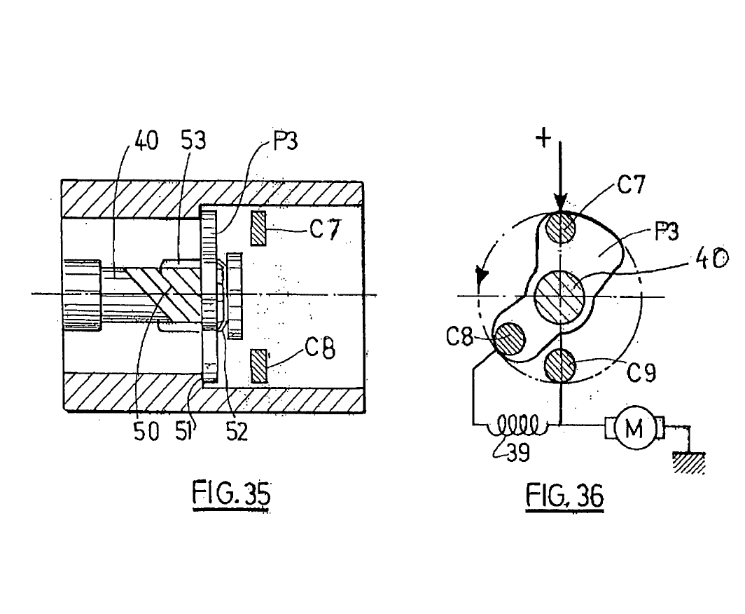

In a third embodiment visible in FIGS. 35 and 36, a contact plate P3 is mounted on a movable shaft 40 fixed to the movable core and comprising at its external periphery helical flutes 50 cooperating with complementary helical flutes produced at the internal periphery of the plate P3. The shaft 40 carries in radial projection a stop 53 for the plate P3.

At rest, the contact plate P3 is kept pressed against a shoulder 54 on the body of the solenoid 2a by an elastic washer 52 fixed to the movable shaft 40. The plate P3 has a special shape, as can be seen in FIG. 36. It comprises two circular sectors, one of which, with a greater circumferential extent, is intended to cooperate with the contact C7 and the other with the contact C8 or C9, axially of the same height. The contacts C7 and C9 are diametrically opposed.

When the movable core moves forward, the plate, driven by the movable shaft and held by the stop 33, follows the translation movement towards the rear. It comes to abut on the first contact C7, which is connected to the vehicle battery, and on the contact C8, itself electrically connected to C9 by the pre-rotation resistive coil 39, thus closing the first power contact since the contact C9 is directly connected to the electric motor.

The movable core continues to advance, and as the plate P3 is axially locked it begins to turn on itself by virtue of the aforementioned flutes and puts C7 and C9 in contact whilst remaining in contact with C8 via the pre-rotation coil 39 in order not to create a break in current. In this position, the resistive coil 39 is short-circuited, which makes it possible to supply the electric motor M of the starter directly with full power.

The contact crushing force is produced by the axial thrust force of the movable core and passed on by the flutes.

When the movable core returns, the movable shaft pulls with it the plate, which abruptly withdraws from the contacts C7 and C9, thus opening the power circuit without closing the first circuit between C7 and C8 again. The electric motor M is thus cut off from any electrical supply.

The plate then comes into abutment against the shoulder 51 on the solenoid body. Being locked in translation, the plate P3 starts to rotate under the pressure of the elastic washer 52, which obliges the plate P3 to return to its initial position by screwing on the helical teeth 50.

To facilitate the rotation of the plate P3 and to prevent any jamming of this plate in the flutes of the movable axis having regard to the slight thickness of the plate and therefore of the tooth, it is possible to envisage a plastic sleeve fitting on the flutes of the movable axis and itself comprising flutes.

FIGS. 29 and 30 depict a preferred embodiment of the fork 13 according to the invention. This fork comprises a rotation shaft 11 carried for example by the starter support 4. Under the effect of the action of the electromagnetic contactor, the fork 13 tilts in rotation about this shaft 11. This fork has a body 292 in the form of a rod producing a rigid connection between the rotation shaft 11 and two arms or branches 293. These two arms are advantageously circular in shape. These two arms each carry a tooth 22, in the form of a finger, oriented towards the front. The tooth has towards the front a preferably circular shape 295 able to cooperate with the notches 320 depicted in FIGS. 31 and 32. The teeth or fingers 22 are in the form of a cylindrical stud. The bottom part of the arms 293 is advantageously provided with shoes 290. These shoes are in the form of a protuberance oriented towards the front as with the teeth 22, that is to say oriented towards the starter head. The front end part of the most advanced shoe 296 can be flat, as depicted in FIGS. 29 to 31. In another embodiment, this end part of the shoe can be curved. In a variant, the fork can have only one shoe 290. At its top end, the fork 13 comprises two lugs 297, perpendicular to the principal shaft of the fork carried by the two branches 298 used for articulation mounting with the movable shaft 40 fixed to the movable core of the contactor. These two lugs 297 serve as a support for the return spring 17 of the fork 13.

FIG. 30 shows us the fork 13 associated with the movable shaft 40 fixed to the movable core 2b, here with a roughly rectangular cross-section. The assembly consisting of movable shaft 40 and movable core has at its front end an H shape perpendicular to the axis of the assembly consisting of movable shaft 40 and movable core and delimiting a recess 300 intended to receive the two branches 298 of the fork 13 for its articulation mounting. This recess 300 has an axial length greater than the thickness of the branches 298 of the fork so as to leave a clearance JC, which fulfils the role of a cutoff clearance in the event of locking of the pinion in the ring of the starter. The arms of the H of the front end of the assembly consisting of movable shaft 40 and movable core extend in projection in order to define in particular a rear shoulder 301 with a rear face 301.

According to one embodiment, the rear face 301 of the rear shoulder of the recess 300 constitutes the front stop of the return spring 18 of the movable core and the rear face 302 of the lugs 297 of the fork 13 constitute the front stop of the return spring 17 of the fork.

In the previous figures the starter head comprises, as in FIG. 1, a driver coupled to the pinion 1 by a coupling device with freewheel.

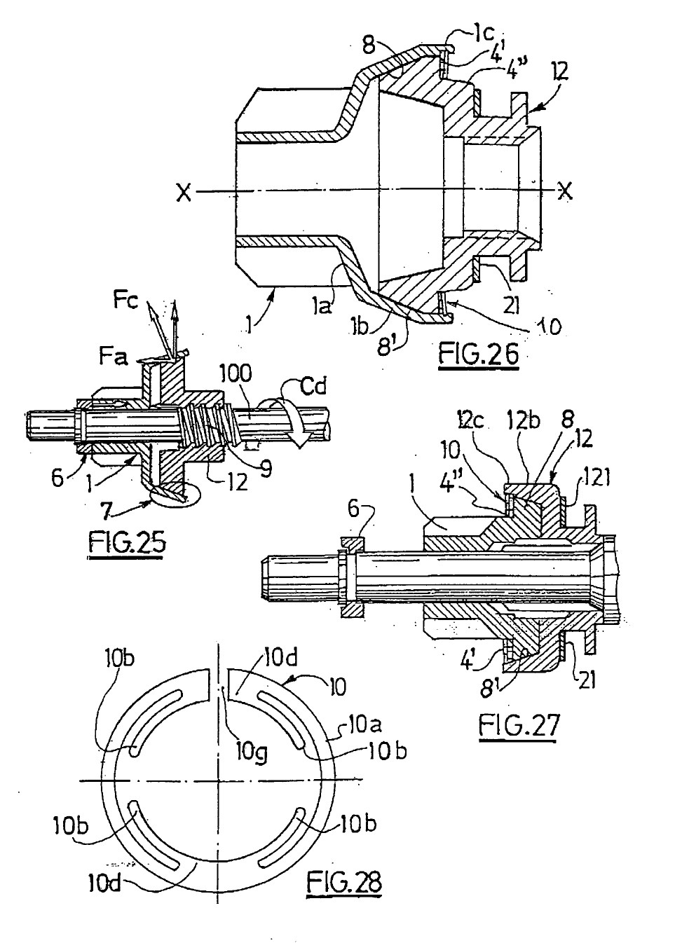

Advantageously, the weight of the starter head can be reduced still further by the use of a coupling device with a conical clutch as described for example in the document FR 01 08607 filed on Jun. 29, 2001. This coupling device, more economical and lighter than that of the freewheel type, will be described below in FIGS. 25 to 28.

This device makes it possible to reduce the weight of the starter head and the number of these components and the axial size of the starter head.

In all cases the fork 13 becomes a mainly follower fork. Because of the reduction in the radial size of the starter head, the two casings can be fixed to each other whilst advantageously being in a single piece 25 (FIG. 5).

The support 4 can be simplified.

In a variant (FIGS. 25 to 28), by virtue of the invention it is possible to use in the aforementioned manner a light-weight starter head, less bulky and with a reduced number of components.

In these figures there is provided a coupling device with a conical clutch 7 (FIG. 25) to couple the pinion 1 to the driver 12. The conical clutch 7 comprises (FIGS. 26 and 27) a first frustoconical friction surface 8, referred to as the first surface, fixed to the pinion 1, and a second frustoconical friction surface 8′, referred to as the second surface, with a shape complementary to the first surface 8 and fixed to the driver 12. The coupling device comprises on the one hand a hollow-shaped coupling piece having a bottom extended by an annular skirt directed axially towards one of the elements consisting of pinion 1 and driver 12 and on the other hand axially acting elastic means 10 bearing on a first stop fixed to the coupling piece for action on a second stop 4′ fixed to one of the elements consisting of pinion 1 and driver 12. The elastic means 10 are carried by the skirt 1b (FIG. 26) or 12b (FIG. 27) of the coupling piece. This skirt firstly internally carries one of the first and second surfaces 8, 8′ and secondly is, via the bottom of the coupling piece, fixed to one of the elements consisting of pinion 1 and starter head 12, which is associated with the surface 8, 8′ carried internally by the skirt, or more precisely by the internal periphery thereof.

Here the diameter of contact of the first surface 8 with the second surface 8′ is greater than the diameter of the tip circle of the pinion teeth.

In these figures the first or second surface 8, 8′ carried by the skirt 1b, 12b is longer axially than the other second or first surface 8′, 8.

The elastic means 10 are carried by the free end of the skirt 1b, 12b and extend in axial projection with respect to the said other second or first surface 8′, 8.

The largest-diameter axial end of the said other surface 8′, 8 is delimited by a transverse shoulder carrying the second stop 4′ for location of the axially acting elastic means 10 with axial compression between this second stop 4′ and a first stop carried by the free end of the skirt of the coupling piece.

The transverse shoulder is extended at its internal periphery by an annular surface 4″ of roughly axial orientation delimiting with the said shoulder a removal of material in order to at least partly house the axially acting elastic means 10.

The axially acting elastic means are here in the form of a circlip and are received in a groove produced at the internal periphery of the free end of the skirt.

These elastic means have in a variant clause intended to come into engagement elastically with the internal periphery of the free end of the skirt of the coupling piece, as described in the aforementioned document FR 01 08607, to which reference can be made for more information.

In FIG. 28 the axially acting elastic means 10 comprise axially deformable tongues 10b and extend circumferentially.

The tongues 10b are curved axially and comprise a washer 10a. In FIG. 28 the axially acting elastic means 10 comprise a washer 10a surrounding the elastic tongues 10b. These elastic tongues are connected to the internal periphery of the washer 10a by means of locating areas 10d. The tongues 10b consist of arms in the form of an annular sector extending circumferentially so as to project on each side of a locating area 10d. The washer 10a has a radial slot 10g symmetrically affecting one of the locating areas 10d; four arms 10b being provided at the rate of two arms per area 10b.

In a variant the first stop is formed by means of a circlip or a stop spring ring mounted in a groove produced at the internal periphery of the free end of the skirt. The elastic means 10 can then consist of at least one Belleville washer or at least one corrugated washer or even a coil spring of frustoconical shape bearing on the circlip or spring ring for action on the driver (FIG. 26) or on the pinion (FIG. 27) for controlled clamping of the surfaces 8, 8′.

In another embodiment the first stop is attached with fixing on the free end of the skirt.

In all cases the axially acting elastic means comprise an elastic washer.

In these figures the free end of the skirt consists of a tubular extension.

In FIG. 26 the skirt of the coupling piece is frustoconical in shape.

Advantageously, for discharge of dust and detachment of the surfaces 8, 8′, one of the first and second friction surfaces 8, 8′ has grooves for contact with the other surface and at least one first and second friction surface 8, 8′ consists in a variant of a friction lining.

In FIG. 26 the pinion 1 is in a single piece with the coupling piece roughly in the shape of a bell and this coupling piece is fixed to the pinion.

In FIG. 27 the structures have been reversed so that the coupling piece is fixed to the starter head 12, which therefore has a cylindrically shaped external skirt 12b at its external periphery.

As a result the driver is in one embodiment obtained by moulding, being for example made from plastics material. In this case the corrugations 21 are easily obtained by moulding as from the front flank 121. In FIG. 25 the breakdown of the forces can be seen when the pinion 1 is in contact with the working stop 6.

More precisely the initial pressure of the elastic means between the stops produces a friction torque between the driver and the pinion which is always, by design, greater than the torque necessary for the screwing and forward movement of the starter head on the shaft 100.

This condition allows the self-initiation of the movement of the starter head between its idle position and its advanced position against the working stop 6 at the start of the phase of driving the vehicle engine via the starting ring. When the pinion reaches the stop 6, there is compression of the surfaces 8, 8′ against each other with locking.

This movement locking between the pinion and the driver depends in particular on the angles and diameters of the frustoconical friction surfaces.

As can be seen in FIG. 25, during the driving of the internal combustion engine of the motor vehicle by the electric motor of the starter, the torque Cd—generated by the starter at the output shaft 100 carrying the driver 12 and transformed by the device with helical flutes 9 acting between the driver 2 and the shaft 100—creates an axial force Fa.

This force Fa is itself broken down at the frustoconical friction surfaces in order to create a normal contact force Fc, which generates a tangential force Ft at the frustoconical surfaces 8, 8′ which is a function of the coefficient of friction between these surfaces. The value of this force Ft multiplied by the mean radius of contact of the frustoconical friction surfaces determines the torque Ce transmitted by the conical clutch 7.

So that the pinion will be driven normally without slip it is necessary for the relationship Ce>Cd always to remain true.

All this depends on the application since the coefficient of proportionality between Cd and Fa depends on the angle of inclination of the flutes 9, the mean radius of these flutes and the coefficient of slip between the output shaft 100 and the driver.

The coefficient of proportionality between Fa and Fc depends on the angle of the cone between the two frustoconical friction surfaces.

The value of Ft is linked to Fc and to the coefficient of friction fc between the two materials of the frustoconical friction surfaces of the clutch 7. To prevent any jamming it will be ensured that the tangent relationship (a)>f′c, in which a is the value of the half-angle at the vertex of the cone of contact between the frustoconical friction surfaces and f′c the coefficient of adhesion.

All these values are calculated according to engineering formulae known per se and dependent on the application.

These formulae involve the coefficient of friction between the flutes on the shaft and on the driver, the mean radius of the flutes, the angle of the cone of the surfaces 8, 8′ and the coefficient of friction of these. All this has an influence on the choice of the materials of the driver, the skirt and the pinion.

When the vehicle engine has started, the pinion 1 turns more quickly than the output shaft 100, which enables the starter head to be unscrewed on the shaft 100. The previously transmitted axial force disappears and there no longer remains anything other than the low residual torque due to the elastic means 10 which is transmitted to the electric motor of the starter. During this short phase of overspeeding the clutch behaves like a freewheel device with a relative movement between the surfaces 8, 8′. The mean diameter of contact between the two surfaces 8, 8′ is therefore also a friction diameter in the event of overspeeding.

FIGS. 31 and 32 illustrate a starter head with a conical clutch provided with means of locking in rotation according to the invention.

In all cases the starter head has a driver provided with a reception groove for the fork. In the figures the driver 12 comprises a transversely oriented front plate, advantageously annular in shape, with a central hole for passage of the starter head shaft 100 associated with the starter head. This plate is extended towards the rear by a tubular portion in the form of a barrel surrounding the shaft 100 and having locally at its internal periphery the helical flutes, more clearly visible in FIG. 25, for cooperation with the complementary helical flutes provided locally at the external periphery of the shaft 100. The tubular portion carries, for example with axial connection, a washer, not referenced in FIGS. 3 and 4, whose front face constitutes the flank 122 of the groove receiving the bottom end of the fork 13. The other flank 121 of this annular shaped groove consists of the rear face of the front plate of the driver. In a variant the flank 122 and its associated washer are moulded with the driver (FIG. 27). The bottom of the groove is axially oriented and is annular in shape. This bottom belongs to the tubular portion on which the arms of the fork are mounted straddling or on which the ring 15 of the fork is mounted for sliding.

In FIG. 27 the front plate is extended towards the front at its external periphery by the skirt 12b. In FIG. 26 the plate is solid and is extended towards the front by the surface 4″. In the variants with freewheel figures the plate is extended at its external periphery towards the front by a cylindrical skirt constituting on the inside a track for the rollers of the freewheel.

The starter in FIGS. 2, 3 and 37 comprising a contactor provided with two contact plates P1 and P2 functions as follows:

when the ignition key constituting the switch 35 of FIG. 2 is actuated, the winding 2a, composed of the attraction winding 36 and the holding winding 37 connected in series with the electric motor M, is supplied, creating a weak magnetic field sufficient to overcome the force exerted by the return spring 18. As a result the movable core 2b moves in the direction of the fixed core 2d whilst compressing firstly the return spring 18 of the core and the return spring 17 of the fork 13;

the movable core takes up the cutoff clearance JC by compressing the return spring 18. During the phase of taking up the cutoff clearance, the fork 13 remains immobile since it is held in place by the fork return spring 17, the stiffness of this fork return spring 17 being greater than that of the return spring 18 of the core. The fork 13, mounted for articulation on the projecting front end of the core 2b, moves and tilts about its point of articulation 11 carried for example by the support 4.

Moving towards the rear, the movable core moves the first contact plate P1 against the first series of contacts C1, C2, which has the effect of energising the attraction and pre-rotation coil 39 of the relay, creating additional forces of attraction of the movable core.

This attraction and pre-rotation coil 39 has an electrical resistance which limits the current passing through the electric motor to a value preferentially between 40 and 80 amperes. This additional pre-rotation coil 39 is wound for example around two other attraction 36 and holding 37 coils in the contactor. Thus means are provided for, following a starting instruction by closure of the starting switch, making the electric motor rotate at a slow speed before making it rotate at full power.

when the armature is set in rotation during the pre-rotation, the movable core pulls the fork 13, which pivots about its axis in order to come into contact with the external face of the driver provided with notches.

under the effect of the rotation of the armature shaft 100, the starter head 102, locked in rotation by the tooth or fingers 22 on the fork inserted in the notches 320 on the driver, begins to move in translation. This translation is effected by virtue of the helical flutes carried by the armature shaft 102 which act like a worm. The angle of the helical flutes, referenced 9 in FIG. 25, is preferably between 18° and 25°. Naturally this angle can be increased in order to have inclinations of around 45°.

By virtue of the rotational locking of the starter head and these means, it is possible to reduce the electromagnetic power and the radial size of the contactor, by virtue of a contribution of energy from the electric motor.

The size and weight of the starter head have a smaller impact on the sizing of the contactor, compared with a conventional contactor, so that it is possible to choose the starter head, which can be lighter or heavier, with fewer constraints.

the fork, still attracted by the movable core, follows the movement of the starter head and therefore remains in contact with the driver, still locking it with respect to rotation. The fork is a follower and does not contribute to the forward movement of the starter head.

In a variant, the fork, in addition to its role of locking the starter head in rotation, can also participate in the forward movement of the starter head by the contribution of a force at its fingers resulting from the movement of the movable core towards the rear.

the pinion then arrives at the ring C of the thermal engine.

if the pinion, by its teeth, can enter directly into the ring C, or more precisely into the teeth thereon, in order to mesh with the ring C, then the starter head continues its movement until the movable core arrives in abutment against the fixed core.

the pinion can also be situated in the tooth against tooth position against the ring. In this case, the pinion is locked with respect to translation and rotation. In this position, the armature supplies a torque proportional to the low-intensity current since the starter is always in the pre-rotation phase. Thus the electric motor exerts a rotation torque on the pinion and the starter head by means of the flutes carried by the armature shaft 100. Being locked in translation, the driver will turn so as to push the fork 13 backwards, which is no longer able to lock the driver in rotation. The fork can be pushed backwards since the winding 2a of the contactor has a force less than the force exerted by the notches on the fork. When the pinion, in turning, finds an opening in the engine ring, it enters therein, pushed by the axial force of the fork generated by the attraction of the movable core by the solenoid 2a.

The value of the current to be made to pass through the first power circuit is sized so that the pinion starts to rotate in the tooth/tooth phase, that is to say the armature has the torque necessary for the pinion to make the notches jump and push the fork backwards. The value of this current is a function of the angle of the helical flutes, the shape of the notches and the sizing of the solenoid 2a.

Thus if, before meshing with the ring C, the pinion abuts against the ring C, the pinion begins to exert a torque on the notches such that the teeth 22 will jump from the notches, making the fork 13 move back. The pinion can then turn and enter the ring. The movement takes place at low speed because of the slow-speed rotation of the electric motor. Wear is thus reduced because of the weak impact made by the pinion when it comes into contact with the ring by virtue of its low axial speed.

The means of cooperation between the starter head and the fork, which form in the figures illustrated means of locking in rotation, are therefore of the disengageable type; the starter head being able to move in translation and fixed with respect to rotation during the aforementioned movement, whilst the shaft of the starter head 100 is able to move in rotation and is fixed with respect to translation, which enables the starter head to advance axially via the aforementioned helical flutes.

The contactor 2 thus becomes a part of reduced dimensions and its specification becomes independent of the sizing of the starter head.

once the pinion 1 has successfully been introduced into the ring 6 under the effect of the armature rotation, it continues its travel forwards under the effect of the rotation of the armature.

with regard to the relay, the movable core comes into abutment against the fixed core, which has the effect firstly of closing the power contact between C3 and C4 by means of the second plate and secondly disengaging the fork from the notches in the starter head. The pinion can arrive at the end of its travel against the stop on the shaft whilst being released from the fork. The rotational locking is thus disengageable when the pinion 1 comes into abutment against the starting ring.

the power contact C3 and C4 being closed by means of the second plate, the armature of the electric motor is then supplied under full power. It can consequently drive the ring C in order to provide the starting of the thermal engine.

when there is decompression of the thermal engine during the starting phase, the ring C becomes driving with respect to the starter head. This phase is called the freewheel phase during which the pinion has a tendency to screw onto the helical teeth again, which has the effect of withdrawing it.

the function of the two shoes 290 provided at the base of the fork is to prevent an excessively great withdrawal of the starter head during the freewheel phase during which the pinion has a tendency to screw on again as described previously. In the absence of these shoes 290, this withdrawal would result in putting the notches in the driver in contact with the fingers on the fork, which would cause wear and noise. These shoes come into abutment (FIG. 31) on a rim 310 situated at the periphery of the driver. The shape of the arms on the fork which supports these fingers and these shoes is such that the shoes can be in contact with the driver only when the fork is in the pivoting position or the position of maximum rotation.

After opening of the switch by means of the ignition key, the winding 2a is de-energised, which has the effect of cancelling the attraction force on the movable core 2b. The fork return spring 17, aided by the springs 18, 20 and 21 bearing respectively on the fork and the movable core 2b, obliges the movable core to disengage and resume its idle position. The movable shaft 40, fixed to the core, pulls the plate P2 with it. The protrusion on the blade 23 comes into abutment on one face of the plate P1. The angle of the slope of this protrusion is sized (approximately 40°) so that the force necessary for the blade to retract is greater than the contact opening resistance force produced between the plate P1 and the contacts C1 and C2. Thus the plate P1 will follow the movable axis and the two power circuits will open simultaneously. When the plate P1 arrives at the fixed core, it is stopped whilst the movable axis is still retracting. The blade then retracts, the force necessary for this retraction being procured by the springs 18 and 21. The protrusion passes on the other side of the plate and the blade resumes its initial position with respect to the plate P1.

Thus the rotational locking of the starter head and the control of the tooth against tooth position are effected by the latching system disposed on the one hand on the rear face of the driver and on the other hand on the front end of the base of the fork. The starter head is returned to its idle position by virtue of the fork and the rescrewing during the freewheel phase on the flutes of the armature shaft. The maintaining in the idle position is achieved by virtue of the return spring 17 situated between the relay and the fork, just as in a traditional device.

The relay is no longer sized to develop a thrust force. It is little dependent on the weight of the starter head. It is sized so as to overcome, in the initial position, the force exerted by the return spring 17 on the movable core. Subsequently the solenoid 2a will have to have the necessary power to overcome the return springs 18 of the starter head, and the springs 20, 21 for crushing the contact plates in the variants where they are present. The saving in weight of copper, magnetic materials, size, costs and development time are the direct advantages of this undersizing.

It is also good to note that making the armature rotate makes it possible to take up all the functional clearances, and when the pinion transmits its torque to the ring for the first time —the coming alongside phase—there is no impact on a conventional starter, which stresses the mechanics of the starter less.

Thus, in accordance with the present invention, the relay consisting of the electromagnetic contactor comprising the attraction, holding and pre-rotation coils is no longer sized so as to develop a force for thrusting the driver forwards for the purpose of the meshing of the pinion in the ring C of the thermal engine. Its sizing is little dependent on the weight of the starter head. It is sized solely so as to be able to overcome the force exerted by the return springs on the movable core when the solenoid is energised. It must also be sized so as to allow the rotation of the starter head when the pinion is in the tooth against tooth position by a backward movement of the fork, which can disengage from the ratchet teeth by virtue of a slight movement of the movable core forwards.

The saving in weight of copper, magnetic materials, size, cost and development time are direct advantages of this undersized contactor according to the present invention. Another advantage of this invention consists of the fact that the starter does not comprise additional parts for the use of a contactor and driver according to the invention.

However, the entry of the starter head by pre-rotation of the armature may require fitting a switching system with two contacts in the relay, where the pre-rotation current exceeds the limit given by the control system (the ignition key), one to allow a low power to pass (current limited to 80 amperes), the other to allow the entire power available to pass.

According to another embodiment, a starter with no tooth against tooth spring and pre-rotation device can be envisaged. Thus, as soon as the ignition key is actuated, all the power is allocated to the armature. A single-contact relay would be sufficient. In this variant embodiment with no tooth against tooth spring, it is the high acceleration of the armature on starting which would make the starter head advance by itself by inertia by being screwed onto the helical flutes of the armature shaft without rotational locking by a fork. The tooth against tooth problem would no longer appear because of the continuous rotation of the pinion during its forward travel by screwing on the armature shaft. In this variant the starting principle of inertia starters is found once again.

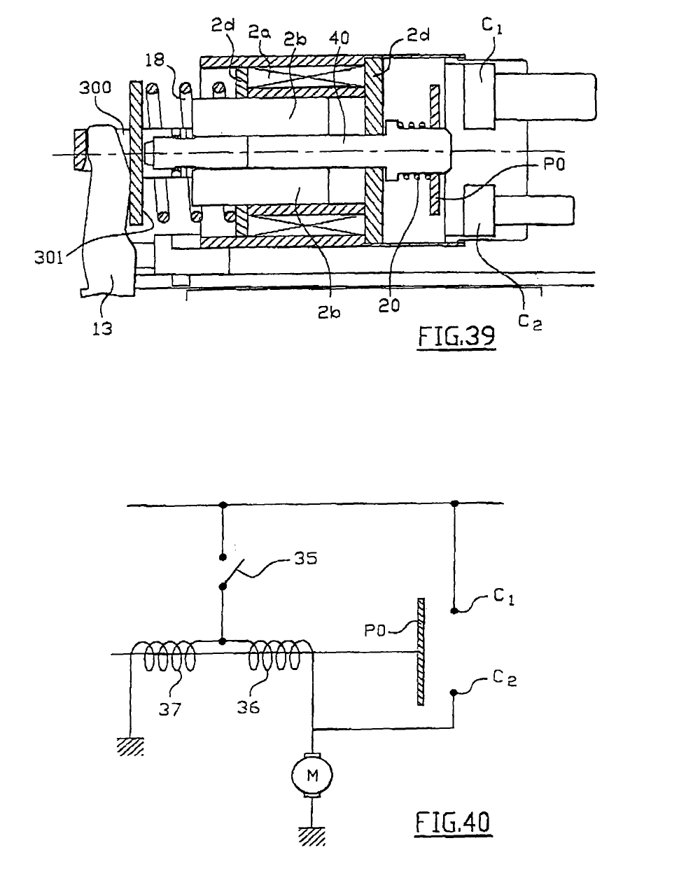

FIGS. 39 and 40 illustrate another embodiment of the pre-rotation according to the invention.

In this embodiment, as depicted in FIG. 4, when the switch 35 closes, a current is caused to pass through the holding coil 37 and the attraction coil 36. This current, in particular the one passing through the attraction coil 36, must be sufficient to actuate the electric motor M in a pre-rotation movement, that is to say it must be sufficient to enable the electric motor M to overcome the friction forces which appear when the starter is started up. These friction forces appear for example at the flutes cooperating with the starter head, at the fork in abutment against the groove in the driver, and in particular depends on the shapes of the means of cooperation between the teeth on the fork and the internal face of the groove in the driver for its rotational locking as described previously.

As soon as the contact plate P0 comes into contact with the power studs C1 and C2, the electric motor is activated at full power and the holding coil remains active whilst the attraction coil 36 is short-circuited.

FIG. 39 illustrates a contactor allowing an effective pre-rotation and which uses solely an attraction coil 36 and holding coil 37 without using any additional resistive elements such as an attraction and pre-rotation coil 39 as described previously. Such a contactor has the advantage of using only two springs, namely a return spring 18 for the core and a contact spring 20 for guaranteeing good contact between the contact plate P0 and the power studs C1 and C2.

In such a contactor, it is no longer necessary to have a tooth against tooth spring against the ring since this configuration is now managed by the fork and the pre-rotation. In this case, as described previously, the pinion is locked with respect to translation and rotation. In this position, the armature supplies a torque proportional to the low-intensity current since the starter is always in the pre-rotation phase. Thus the electric motor exerts a rotation torque on the pinion and the starter head by means of the flutes carried by the armature shaft 100. Being locked with respect to the translation, the driver will turn so as to push the fork 13 backwards, which is no longer able to lock the driver in rotation. The fork can be pushed backwards since the winding 2a of the contactor has a force less than the force exerted by the notches on the fork 13. When the pinion, in turning, finds an opening in the engine ring, it enters therein, pushed by the axial force of the fork generated by the attraction of the movable core by the solenoid 2a.

Likewise, in such a contactor, it is no longer necessary to use a cutoff spring since the movable core 2b comprises a movable shaft 40 which is integral with respect to translation (coupled shaft) so that it is the return spring 18 which serves as a cutoff spring.

The fork 13 is identical to the one described in FIGS. 3, 4, 29 and 30 and allows rotational locking of a starter head similar to that described in FIGS. 3, 4, 31, 32, 33.

Advantageously, during pre-rotation, in addition to the function of rotational locking of the starter head, the fork also assists the starter head to move forwards by virtue of the force exerted towards the rear by the movable core 2b under the effect of the magnetic field created by the current passing through the solenoid 2a. The movement of the starter head is thus assisted whilst reducing the risks of jamming at the flutes.

The connection terminal of the electric motor in FIG. 1 is replaced by an internal connection.

This is made possible because the rear bearing 26 is made from plastics material so that the electrical tracks are obtained by the overmoulding technique.

The rear bearing has a sleeve for receiving the rear end of the shaft 101. This sleeve carries internally a bearing in which the rear end of the shaft 101 is rotatably mounted. The resistance 35, for example made from aluminium, is wound and connected to the contacts C1 and C2.

In FIG. 3 the resistance is wound around windings 36 and 37.

As a result the two casings can form part of the same piece or be fixed to each other. The support 1 can be obtained by deformation of material whilst for example being made from pressed sheet metal. It then has a fixing and centring flange instead of the deeper fixing area in FIG. 1. The rear bearing of the electric motor advantageously constitutes the contactor closure plate. The rear bearing is then, in one embodiment, equipped with one or more electrical tracks, for example by overmoulding. This track or tracks connects at least one fixed contact to the electric motor so that it is possible to eliminate the cable of FIG. 1.

The rear bearing 26 is attached by clipping 29 to the casing 25 and closes the latter on the opposite side to the support 4. For example, the casing 25 has holes and the bearing 26 elastically deformable tongues each carrying a lug with a ramp.

When the tongues of the bearing 26 are slipped into the casing, they retract downwards by virtue of the ramps on the projecting lugs. When the lugs arrive opposite the holes, the tongues are deployed and the lugs enter the holes. Several lugs and holes are provided.

The casing 25 has the shape shown in FIG. 6 and has two cavities receiving respectively the electric motor M and the contactor 2. Here the casing 2 is formed by means of a closed metal strip, for example roughly oval in shape, which is deformed by means of jaws in contact with movable cores delimiting the cavities.

The strip can be open originally and be closed by dovetailing as described in the document U.S. Pat. No. 4,309,815 or by welding. The casing is made from magnetic material, for example sheet metal.

In a variant the two casings are fixed to each other for example by welding.

The support 4 is made from sheet metal and is obtained by deformation of material without any reworking operation, only anticorrosion surface treatment possibly being carried out. It is possible to use for example precoated metal sheets. The support 4 (FIG. 5) is produced by pressing and has a front part 43 in the shape of an ogive provided with a sleeve 42 carrying internally a bearing supporting the front end of the starter head. The ogive 4 has an opening 44 for the starting ring to pass.

The ogive is connected at the rear to a fixing flange 45 of transverse orientation, that is to say perpendicular to the rotation axis X-X of the shaft 100-101.

The flange, of simple shape, replaces the more complex fixing area of FIG. 1. Stiffening ribs 47 are present between the flange 45 and the ogive 43.

Hollow studs 41 are produced for the fixing and centring of the support on the crankcase of the thermal engine of the vehicle and thus constitute the aforementioned third fixing and centring means.

A spherical cap can be seen at 46 for creating a space through the front end of the movable core 2b of the contactor 2, the number of whose springs is reduced compared with that of FIG. 1. The fixed core 2d, 2d is also simplified since it consists of a simple plate without any frustoconical portion as in FIG. 1. The same applies to the movable core 2b.

A support washer is provided for supporting the return spring 18.

The first means of fixing and centring the support 4 are used for fixing the casing 25.

In a variant the ogive 43 is made from pressed sheet metal and the flange 43 from aluminium.

The casing 25 can be pressed in order to form hollow nesting means for entry of lugs issuing from the casing and the formation of centring means.

Here the casing 25 is fixed by crimping to the support 4, as can be seen for example in FIGS. 8 to 24.

These embodiments are also applicable to the fixing of the casing to the rear bearing.

These solutions are economical since this avoids having recourse, as in FIG. 1, to a screwing machine which is expensive from the investment point of view if it is wished to take account of the precise screwing parameters.

In addition, this type of assembly with screws or tie rods is bulky and poses additional constraints in the automation of the assembly stations (distribution of long or small parts, little space for the passage of the heads of the screwing machines). In addition the cycle time of a screwing operation is traditionally long.

In FIGS. 8 to 24 these drawbacks are not found. In these figures a part of the casing 25 is deformed in order to immobilise the other components so that the size of the starter is reduced. Thus the support 4 or the bearing 26 can have holes through which there pass axially lugs on the casing whose free ends are folded over in contact with the support or the bearing.

The reference 28 in FIG. 3 represents such an assembly.

In a variant (FIG. 8) the support 4 or the bearing 26 have cavities 70, for example in the form of hollows in which noses 71, 72 obtained by cutting from the casing 25 are folded over. The noses are in abutment on the lateral edges of the hollows, thus achieving an angular location and a rotational stop.

In FIG. 9 the two noses are joined in order to form a strip of material 73 deformed in the cavity 70.

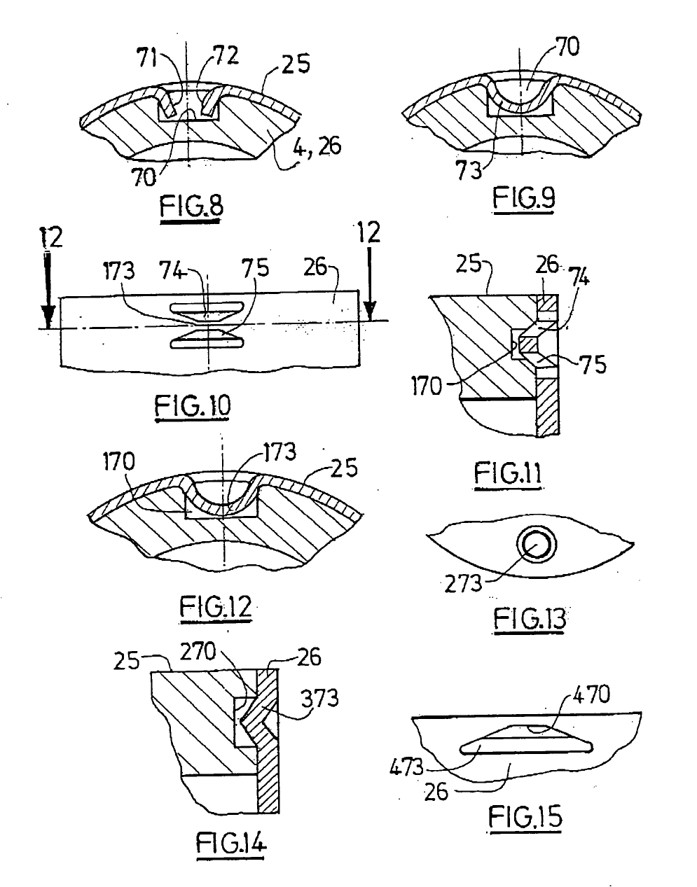

In FIGS. 10 to 12 such a strip of material is formed but the hollow 170 extends parallel to the axis X-X of the shaft 101, instead of being perpendicular thereto. The strip 73 is formed by means of recesses 74, 75 opposite each other. In this way axial and radial fixing is obtained without the need for fitting in.

In FIG. 14, the wall of the piece 26 (or in a variant 4) is deformed locally at 373 by pushing it inside the hollow 270 by means of a punch, here prismatic in shape or in a variant conical or cylindrical it is possible to reverse the structures, the casing 25 being deformed locally in order to enter the hollow 70, 170, 270 forming a cavity so that the bearing 26 can be made from plastics material.

FIG. 13 depicts a local deformation of material by means of a cylindrical punch revealing a deformation of material 273 entering for example the hollow 270.

In a variant in FIG. 15 a single recess 470 is provided, the top part of FIG. 10, that is to say the recess 74, being omitted. In a variant, FIG. 16, the recess 470 in FIG. 15 is open and two tongues 471, 472 are formed, the reference 473 being a solid part.

In a variant in the figures in FIG. 17, instead of passing through a hole, the axial lugs 77 pass through a recess 76 in the form of a notch and the precut lateral edges 77′ of the lugs, for example of the casing 25, are folded over in contact with the lateral edges of the notches produced in the support or bearing.

In a variant the lateral edges 77′ consist of protuberances connected to each other by a removal of material and the protuberances are crushed.

In a variant, FIG. 19, fitting in is carried out. The bearing 27 has for example support protuberances 79 for the bottom face of the casing 25.

The piece 26 has a collar 78 folded over radially by crimping or folding in contact with the top face of the casing 25.

In a variant (FIG. 20), the collar is deformed axially at 178 in contact with the top face of the casing 25. In a variant, FIG. 21, a cutout is formed in the collar by means of a punch, with an inclined lug 278 folded over in contact with the top face of the casing.

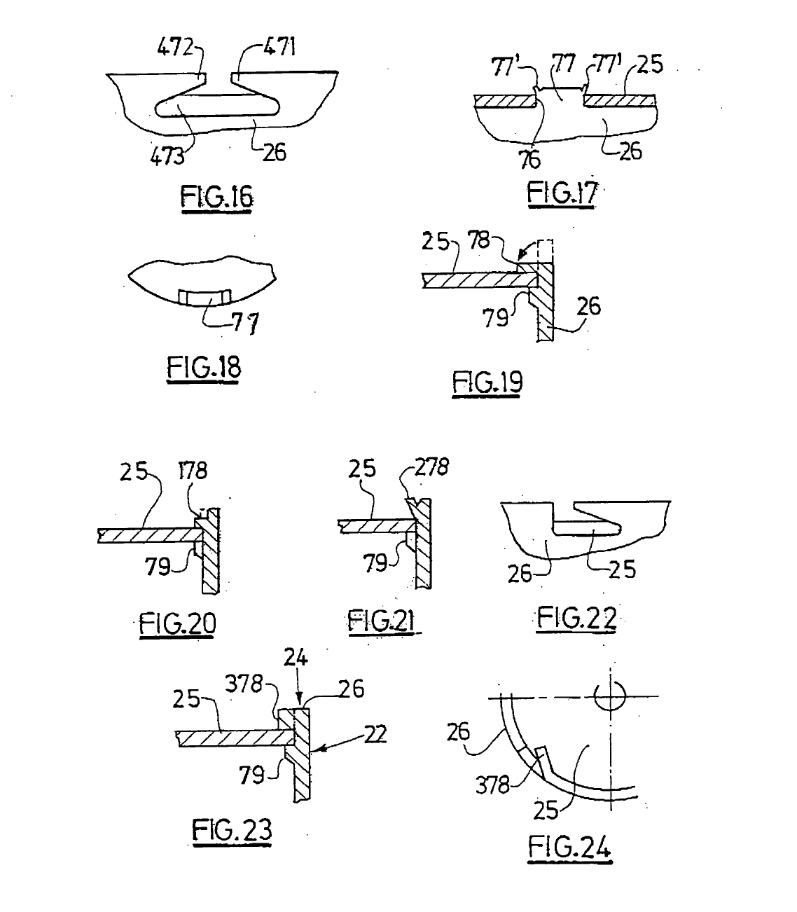

In a variant an inclined lug 378 (FIGS. 22 to 24) is folded over in contact with the top face of the casing 25.

Everything which has just been described is applicable to the flange 28 of the support 4.

The device for coupling between the driver 12 and the pinion comprises a freewheel in one example embodiment. This freewheel uses a large number of components because in particular of the presence of rollers each subjected to the action of a spring. The coupling device with a conical clutch affords great simplification in the aforementioned manner.

By virtue of the invention and the rotational locking of the driver, the movement of the starter head is assisted by reducing the risks of jamming at the flutes. In relation to the previous figures the most compact possible solution is arrived at with an appreciable reduction in the number of components and the weight. The solution is simple and economical.

Naturally the present invention is not limited to the example embodiments described. In particular the support in a variant is of the type in FIG. 1 and the two casings can be distinct. A gearbox is in a variant interposed between the two shafts and/or a cable is provided between the motor M and the contactor as in FIG. 1.

The inductor of the electric motor M in a variant comprises a winding. Tie rods can connect the support to the rear bearing. The brushes in a variant are axially oriented as in FIG. 1.

Naturally the embodiments presented above are also adapted for starters with armatures with magnets or wound, of the direct engagement type or with an internal gearbox and a support with an ogive or of the emerging pinion type.

1. Starter for a motor vehicle with a thermal engine and a starting ring of the thermal engine, comprising a starter head, provided with a driver (12) and a pinion (1), able to pass from a retracted idle position to an advanced position of meshing with the starting ring (C) of the motor vehicle thermal engine, an electric motor (M) provided with a shaft (101) able to drive a starter-head shaft (100) associated with the starter head (12), complementary helical flutes (9) acting locally between the internal periphery of the driver (12) and the external periphery of the starter-head shaft (100), an electromagnetic contactor (2) extending parallel to the electric motor (M) above it and comprising a movable core (2d), a fork (13) mounted for articulation at its top end on the movable core (2b) and at an intermediate point (11) on a support (4) of the electric motor (M) and electromagnetic contactor (2), in which the driver (12) comprises a groove for receiving the bottom end of the fork (13) delimited by two flanks (121, 122) and in which means are provided for making the electric motor turn at a slow speed in a first so-called pre-rotation phase and then at full power, characterised in that the starter head is rotationally locked by means of cooperation between the fork (13) and the driver (12) for its passage from its idle position to its position of meshing with the starting ring.

2. Starter according to claim 1, characterised in that the cooperation means d are means of locking in rotation with cooperation of shapes.

3. Starter according to claim 1, characterised in that the cooperation means are of the friction type.

4. Starter according to claim 2, characterised in that, when the electromagnetic contactor (2) is supplied electrically, the fork (13) cooperates with the flank (121), referred to as the front flank of the fork reception groove (13), and in that the said front flank (121) is provided with circumferential corrugations (21).

5. Starter according to claim 4, characterised in that the fork (13) has arms (293) with corrugations of complementary shape to those on the front flank (121).

6. Starter according to claim 2, characterised in that the means of locking in rotation are of the ratchet tooth type.

7. Starter according to claim 2, characterised in that the front flank (121) of the reception groove of the fork (13) comprises notches (320) and protrusions (321), whilst the fork (13) has projecting fingers (22) cooperating with the notches (320) for the rotational locking of the starter head.

8. Starter according to claim 1, characterised in that the front flank (121) of the fork (13) reception groove cooperates with a ring (15) mounted so as to slide axially on the barrel of the driver.

9. Starter according to the preceding claim, characterised in that the ring (15) is mounted for articulation on the body (292) of the fork (13).

10. Starter according to claim 1, characterised in that the fork (13) has at its end which cooperates with the groove of the driver at least one shoe (290) which cooperates with a rim (310) situated at the periphery of the driver when the starter head is meshed in the starting ring of the motor vehicle engine.

11. Starter according to claim 1, characterised in that the cooperation means are disengageable.

12. Starter according to claim 1, characterised in that the support (4) has a front part (43) made from sheet metal roughly in the shape of an ogive.

13. Starter according to claim 12, characterised in that the front part is connected to a fixing and centring flange (45).

14. Starter according to claim 13, characterised in that the sheet-metal support (4) is obtained by deformation of material, such as pressing, and in that the flange (45) is made in a single piece with the front part (43).

15. Starter according to claim 1, characterised in that the electric motor (M) and contactor (2) each have a casing fixed to the other casing.

16. Starter according to claim 15, characterised in that the two casings belong to one and the same piece (25).

17. Starter according to claim 16, characterised in that the casing or two casings are closed on the opposite side to the support by a common piece (26) forming the rear bearing of the electric motor (M).

18. Starter according to claim 1, characterised in that the means provided for making the electric motor (M) turn in pre-rotation and then at full power comprise two plates (P1, P2) carried by the movable core (2b), the first plate (P1), used during pre-rotation, is connected to two contacts (C1, C2), the first contact (C1) is connected to the resistive coil (39), the second contact (C2) is connected to the positive terminal of the battery, and then, during full power, the second plate (P2) is connected to two contacts (C3, C4), the third contact (C3) is connected to the resistive coil (39) and to the electric motor (M), and the fourth contact (C4) is connected to the positive terminal of the battery.

19. Starter according to claim 1, characterised in that a contact plate (P0) is allowed to rock about the second fixed contact (C5) in order to cooperate with another fixed contact (C6) offset axially and connected to the positive terminal of the battery in order to supply the electric motor.

20. Starter according to claim 18 or 19, characterised in that the movable shaft (23) comprises a blade (23) provided with a local protrusion which drives the contact plates (P0, P1) when the movable shaft (40) returns after opening of the control circuit of the contactor (2).

21. Starter according to claim 1, characterised in that the electromagnetic contactor (2) comprises at least one plate (P3) able to rotate about the movable shaft (40) for putting the electric motor (M) in pre-rotation and then at full power.

22. Starter according to claim 21, characterised in that the plate (P3) has two electrically connected studs, a first stud continuously electrically connected with a contact (C7) connected to the battery voltage, a second stud connected to a contact (C8) when the motor is pre-rotated, this second stud then coming into contact with a third contact (C9), after rotation of the said plate (P3), in order to provide full power to the starter, the second and third contacts (C8, C9) being connected together by the pre-rotation resistive coil (39), the contact (C9) being connected to the electric motor (M).

23. Starter according to claim 1, characterised in that the pinion (1) of the starter head is connected to the driver by a device for coupling to the conical clutch.
